(19) United States
(12) Patent Application Publication
(10) Pub. No.: US 2023/0026981 A1
(43) Pub. Date: Jan. 26, 2023

(54) OBSCURING DIGITAL VIDEO STREAMS VIA A PANIC BUTTON DURING DIGITAL VIDEO COMMUNICATIONS

(71) Applicant: POPio IP Holdings, LLC, Sandy, UT (US)

(72) Inventors: Timothy Eugene Pranger, Eagle Mountain, UT (US); Ryanne Mayers, Sandy, UT (US); Robert Eric Roy, Riverton, UT (US); Austin Barnes, Riverton, UT (US)

(21) Appl. No.: 17/383,191

(22) Filed: Jul. 22, 2021

(51) Int. Cl. H04N 7/14; G06F 3/0484; G06F 3/0482

(52) U.S. Cl. CPC H04N 7/141; G06F 3/0482; G06F 3/0484

(57) ABSTRACT

This disclosure describes methods, non-transitory computer readable storage media, and systems that obscure digital video streams during digital video communications while maintaining connections corresponding to the digital video communications. The disclosed system determines that a first user client device is involved in an ongoing digital video communication with a second user client device in which the first client device is receiving a digital video stream from the second user client device. The disclosed system provides, to the first user client device, an option to obscure the digital video stream from the second user client (e.g., via a “panic button” interface element). In response to a selection of the option, the disclosed system then obscures the digital video stream at the first user client device while maintaining a connection corresponding to the digital video communication between the first user client device and the second user client device.

### BACKGROUND

Many modern businesses create software applications (e.g., mobile applications) meant to improve accessibility to the business and allow a user to perform some desired function or access information on a client device (e.g., mobile device, laptop, etc.). For example, some businesses, such as banks, may create a software application to provide customers a convenient alternative to visiting a brick-and-mortar branch of the business. To illustrate, software applications can include operations for exchanging information (e.g., documents), creating accounts, initiating transactions, or otherwise conducting business via digital communications. This allows the user flexibility in determining when and where to interact with the business.

Additionally, improvements to computer processing and networking technologies have led to significant advancements in the fields of video conferencing. For instance, many systems provide capabilities for users to engage in user-to-user or user-to-business video communications. Accordingly, integrating video communication options in software applications designed for users to interact with business provides the users with additional alternatives to in-person interactions. Specifically, digital video communications can provide an enhanced interaction experience over text or audio communications, thereby improving the abilities of businesses to assist consumers (or prospective customers).

While digital video communications provide improved communication options between users and businesses, conventional communication systems have several technological shortcomings. In particular, conventional systems that provide video communications (e.g., via two-way video or video conferencing software applications) lack safety and security protocols related to video communications. Specifically, especially for businesses, most video communications are in-bound video requests from unknown users, which results in recipient users not knowing who is requesting the video communication until a connection is established. While conventional systems typically allow recipients to reject calls from unknown users, such measures do not protect the recipients from seeing content that they may not want to see. For example, inattentive users or malicious users requesting to engage in video communications with recipients can result in the recipients seeing content such as requesting users in inappropriate stages of dress or offensive content. Thus, the conventional systems fail to provide a safe and secure communication environment for recipients of video communication requests.

### SUMMARY

This disclosure describes one or more embodiments of methods, non-transitory computer readable media, and systems that solve the foregoing problems (in addition to providing other benefits) by obscuring a digital video stream of a user to a recipient during a digital video communication. In particular, the disclosed systems determine that a first user client device is involved in an ongoing digital video communication with a second user client device in which the first client device is receiving a digital video stream from the second user client device. The disclosed systems provide, to the first user client device, an option to obscure the digital video stream from the second user client (e.g., via a “panic button” interface element). In response to a selection of the option, the disclosed systems then obscure the digital video stream at the first user client device while maintaining a connection corresponding to the digital video communication between the first user client device and the second user client device. Accordingly, the disclosed systems stop displaying (or otherwise obscure) a digital video stream in response to a user input while a digital video communication is ongoing without terminating the connection associated with the digital video communication.

Additional features and advantages of exemplary embodiments of the present disclosure will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter. The foregoing summary is not an extensive overview, and it is not intended to identify key elements or indicate a scope. Rather the foregoing summary identifies aspects of embodiments as a prelude to the detailed description presented below.

### BRIEF DESCRIPTION OF THE DRAWINGS

The detailed description refers to the drawings briefly described below.

FIG. 1 illustrates a block diagram of a system environment in which a video obscuring system is implemented in accordance with one or more implementations.

FIG. 2 illustrates an overview diagram of the video obscuring system obscuring a digital video stream in accordance with one or more implementations.

FIGS. 3A-3B illustrate diagrams of the video obscuring system obscuring digital video streams during a digital video communication in accordance with one or more implementations.

FIG. 4 illustrates a graphical user interface including administrative settings for digital video communications in accordance with one or more implementations.

FIG. 5 illustrates a graphical user interface of a user client device for initiating a digital video communication in accordance with one or more implementations.

FIG. 6 illustrates a flowchart of a series of acts in a method of initiating a digital video communication between a mobile device and an additional device in accordance with one or more embodiments.

FIG. 7 illustrates a graphical user interface of a user client device presenting a digital video communication in accordance with one or more embodiments.

FIGS. 8A-8E illustrate graphical user interfaces of an agent client device for engaging in a digital video communication and obscuring a digital video stream in accordance with one or more implementations.

FIGS. 9A-9B illustrate graphical user interfaces of a user client device obscuring a digital video stream in accordance with one or more embodiments.

FIG. 10 illustrates a schematic diagram of a system for sending modified display elements in accordance with one or more embodiments.

FIG. 11 illustrates a diagram including the video obscuring system of FIG. 1 in accordance with one or more implementations.

FIG. 12 illustrates a flowchart of a series of acts for obscuring a digital video stream during a digital video communication in accordance with one or more implementations.

FIG. 13 illustrates a block diagram of an exemplary computing device in accordance with one or more embodiments.

### DETAILED DESCRIPTION

This disclosure describes one or more embodiments of a video obscuring system that improves computing systems that provide digital video communications between users by obscuring digital video streams while maintaining connections associated with the digital video communications. Specifically, in one or more embodiments, the video obscuring system first determines that at least two user client devices are involved in a digital video communication. Additionally, the video obscuring system provides, to a first user client device, an option (e.g., a “panic button”) to obscure a digital video stream received from second user client device during the digital video communication. In response to receiving a selection of the option, the video obscuring system can obscure the digital video stream at the first user client device while maintaining the connection between the user client devices. Thus, the video obscuring system can maintain the connection to resume presenting the digital video stream at the first user client device (e.g., in response to determining that the selection was accidental) or terminate the connection (e.g., upon confirmation that the selection was intended) to improve the security of digital video communications between a plurality of users.

As mentioned, in one or more embodiments, the video obscuring system determines that a first user client device is engaged in a digital video communication with a second user client device. For example, the video obscuring system establishes a connection between the first user client device and the second user client device in response to a request to initiate a digital video communication between the user client devices. Once the connection is established, the video obscuring system can provide at least one digital video stream via the connection from one user client device to the other (e.g., from the second user client device to the first user client device). The video obscuring system can also provide a digital audio stream in connection with the digital video stream.

Additionally, in connection with determining that user client devices are involved in a digital video communication, the video obscuring system can provide, for display at the first user client device, an option to obscure a digital video stream received from the second user client device. For instance, the video obscuring system can provide a graphical user interface element (e.g., a “panic button”) during ongoing digital video communications. In one or more embodiments, the video obscuring system enables the option to obscure the digital video stream at the first user client device based on an administrative setting.

In one or more embodiments, the video obscuring system receives a selection of an option to obscure a digital video stream during a digital video communication. Specifically, the video obscuring system can receive the selection of the option while providing the digital video stream from the second user client device for display at the first user client device. To illustrate, the video obscuring system can detect an interaction with a graphical user interface element presented at the first user client device while presenting the digital video stream from the second user client device at the first user client device.

Furthermore, in one or more embodiments, the video obscuring system obscures a digital video stream in response to a selection of an option to obscure the digital video stream. For example, the video obscuring system obscures the digital video stream by preventing the digital video stream from being presented at the first user client device. Alternatively, the video obscuring system obscures the digital video stream by applying a distortion filter (e.g., a blur filter) to the digital video stream when presented at the first user client device. In some embodiments, the video obscuring system also prevents a digital audio stream from being presented at the first user client device. In additional embodiments, the video obscuring system can also obscure a digital video stream and/or digital audio stream from the first user client device at the second user client device.

In one or more additional embodiments, the video obscuring system also verifies a selection of an option to obscure a digital video stream. In particular, the video obscuring system can provide a request to confirm or reject the selection to obscure the digital video stream at the first user client device. In response to a confirmation of a request to obscure the digital video stream, the video obscuring system can continue obscuring the digital video stream and/or terminate the corresponding digital video communication. In response to a rejection of the request to obscure the digital video stream, the video obscuring system can present the digital video stream unobscured at the first user client device.

In response to obscuring a digital video stream, the video obscuring system can also provide a notification to a user client device that provided the digital video stream. For instance, in response to a confirmation of a request to obscure the digital video stream, the video obscuring system can provide the notification to the second user client device. In one or more embodiments, the notification includes a warning associated with content of the digital video stream. Furthermore, the notification can also include an indication that a user of the second client device has been reported to a third-party.

The disclosed video obscuring system can provide a number of technical advantages over conventional systems. For example, the video obscuring system can improve safety and security of computing systems that provide digital video communications between two or more computing devices. To illustrate, in contrast to conventional systems that merely allow users to reject requests from unknown users, the video obscuring system can provide additional security for recipients of requests for digital video communications in situations for which rejecting requests is not common practice (e.g., in customer support positions). Indeed, by providing an option for a user to instantly obscure digital video streams received from other users during ongoing digital video communications with the other users, the video obscuring system can allow the users to quickly hide/obscure inappropriate or offensive content.

Additionally, the video obscuring system can improve the flexibility and efficiency of computing systems by obscuring digital video streams during digital video communications. For instance, in contrast to existing systems that merely allow users to reject or terminate video chats, the video obscuring system obscures a digital video stream during a digital video communication while maintaining a connection corresponding to the digital video communication. By maintaining the connection between user client devices, the digital video communication can quickly provide the unobscured digital video stream (e.g., based on determining that a request to obscure the digital video stream was not intentional). Thus, the video obscuring system provides flexibility and efficiency with an additional mechanism for managing the receiving and displaying of digital video streams during digital video communications.

As illustrated by the foregoing discussion, the present disclosure utilizes a variety of terms to describe features and advantages of the video obscuring system. Additional detail is now provided regarding the meaning of such terms. For example, as used herein, the term “digital video communication” refers to a communication having a video element. In particular, a digital video communication can refer to a multi-directional communication involving at least two computing devices such as a first user client device and a second user client device in which users of the computing devices (e.g., a customer user and an agent or support representative) can communicate, and at least one of the computing devices displays a video capturing a video element of the communication. For example, at least one of the computing devices can display a video stream captured by a camera associated with the at least one other computing device participating in the digital video communication.

Additionally, as used herein, the term “digital video stream” refers to video content captured at a first client device during a digital video communication. For example, a digital video stream can include real-time video of a user captured by a first client device to provide to a second client device involved in a digital video communication with the first client device. In one or more embodiments, a digital video communication includes a plurality of digital video streams from a plurality of client devices involved in the digital video communication for providing to the client devices involved in the digital video communication.

Also as used herein, the term “digital audio stream” refers to audio content captured at a first client device during a digital video communication. For instance, a digital audio stream can include real-time audio of a user captured by a first client device to provide to a second client device involved in a digital video communication with the first client device. In one or more embodiments, a digital video communication includes a plurality of digital audio streams from a plurality of client devices involved in the digital video communication for providing to the client devices involved in the digital video communication.

As used herein, the term “connection” refers to an established communication channel between two or more computing devices. In particular, a connection corresponding to a digital video communication includes a communication channel between two or more computing devices for sending one or more digital video streams via the communication channel. In at least some embodiments, a connection corresponding to a digital video communication transmits data other than a digital video stream including, but not limited to device identifiers, user identifiers, location information, or information associated with a purpose of the digital video communication (e.g., banking information). Accordingly, while a digital video communication is ongoing, a connection corresponding to the digital video communication remains intact even if no digital video/audio streams are being transmitted via the connection.

As used herein, the term “distortion filter” refers to a computing software component that applies a visual distortion to digital image or digital video. For instance, a distortion filter includes a modification to a digital video stream from a client device to distort or otherwise obscure details of the digital video stream. For example, a distortion filter can include, but is not limited to, a blur filter (e.g., a Gaussian blur, a radial blur, or a motion blur) to soften color boundaries by modifying pixel values of a digital image (e.g., individual video frames) as presented on a display device. A distortion filter can also include a filter that changes details of a digital image such as by modifying colors, pixel positions, pixel values, or other modifications to obscure details in the digital image.

As used herein, the term “agent” refers to a representative of an entity. For example, an agent can include, but is not limited to, a support representative of a business (e.g., a bank). In some embodiments, an agent has duties to interact with users (e.g., customers) to provide information associated with an entity or provide assistance in performing operations associated with the entity. Additionally, an agent can be associated with one or more client devices (e.g., an agent client device) for use in engaging in digital video communications with users.

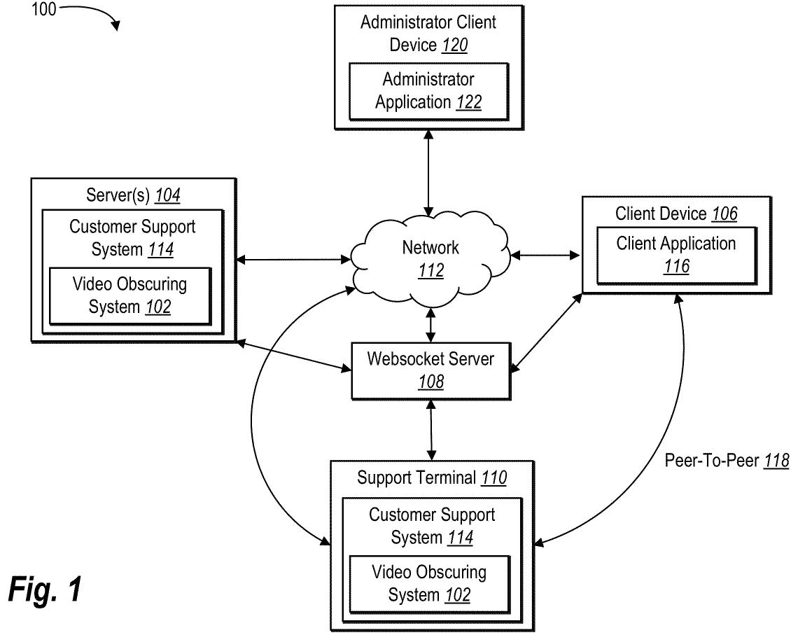

Turning now to the figures, FIG. 1 includes an embodiment of a system environment 100 in which a video obscuring system 102 operates. In particular, the system environment 100 includes server(s) 104, a client device 106, a Websocket server 108, a support terminal 110, and an administrator client device 120 in communication via a network 112. Moreover, as shown, the server(s) 104 include a customer support system 114 (or a portion of the customer support system 114), which further includes the video obscuring system 102 (or a portion of the video obscuring system 102). Additionally, or alternatively, the support terminal 110 includes the customer support system 114 (or a portion of the customer support system 114), which includes the video obscuring system 102 (or a portion of the video obscuring system 102). As illustrated, the client device 106 includes a client application 116, and the administrator client device 120 includes an administrator application 122.

As shown in FIG. 1, the server(s) 104 include or host the customer support system 114. Specifically, the customer support system 114 includes, or is part of, one or more systems that implement digital communications between two or more users of the customer support system 114. For example, the customer support system 114 at the server(s) 104 establishes a connection between the client device 106 and the support terminal 110 (e.g., an agent client device) in response to a request to initiate a digital video communication sent to the customer support system 114 by the client device 106. In particular, the customer support system 114 establishes the connection to allow transmission of data for a digital video communication between the client device 106 and the support terminal 110. Additionally, in response to the customer support system 114 establishing the connection, the customer support system 114 conducts a digital video communication between the client device 106 and the support terminal 110 via the connection. Accordingly, a user and an agent can interact with the client device 106 and the support terminal 110, respectively, to communicate with one another via the digital video communication.

As illustrated, in one or more embodiments, the server(s) 104 comprises one server. Alternatively, the server(s) 104 may comprise a plurality of servers. For example, the server(s) 104 can comprise a video load balance server, a signaling server, and a STUN/TURN server. The video load balance server serves to direct communications to an available support terminal, the signaling server notifies the support terminal 110 of a request to initiate a digital video communication, and the STUN/TURN server serves to work through secure firewalls to establish the connection. Alternatively, any other combinations and types of servers sufficient to establish a connection may be used as part of the server(s) 104.

Additionally, as mentioned, the server(s) 104 can execute or implement at least a portion of the customer support system 114. In particular, in one or more embodiments, the customer support system 114 utilizes the server(s) 104 to conduct digital video communications between a support terminal (e.g., the support terminal 110) and a client device (e.g., the client device 106), provide content to the client device (e.g., display elements for display within the client application 116), and receive data resulting from interaction with the content. For example, in one or more embodiments, the customer support system 114, via the server(s) 104, can conduct a digital video communication between the client device 106 and a support terminal 110, where the digital video communication is transmitted through a first connection (e.g., a first connection between the client device 106 and the support terminal 110). The customer support system 114, via the server(s) 104, can further transmit content to the client device 106 via a second connection (e.g., a second connection between the support terminal and the client device 106). During the digital video communication, the customer support system 114, via the server(s) 104, can receive data resulting from interaction with the content within the client application 116 at the client device 106.

As shown in FIG. 1, the customer support system 114 at the server(s) 104 includes the video obscuring system 102. Indeed, in one or more embodiments, the customer support system 114 executes or implements the video obscuring system 102 in order to facilitate the obscuring of digital video streams presented at the support terminal 110. To illustrate, the customer support system 114 can use the video obscuring system 102 to obscure a digital video stream in response to a request from the support terminal 110 (e.g., based on an interaction with the support terminal 110 by an agent). For example, the video obscuring system 102 can obscure digital video streams (e.g., a digital video stream from the client device 106) by preventing the digital video streams from displaying at the support terminal 110. Alternatively, the video obscuring system 102 can apply a distortion filter to the digital video stream presented at the support terminal 110 during ongoing digital video communications involving the support terminal 110 and one or more client devices (e.g., the client device 106). For instance, the video obscuring system 102 uses distortion settings to determine a degree of distortion to apply to a digital video stream presented at the support terminal 110 during a digital video communication.

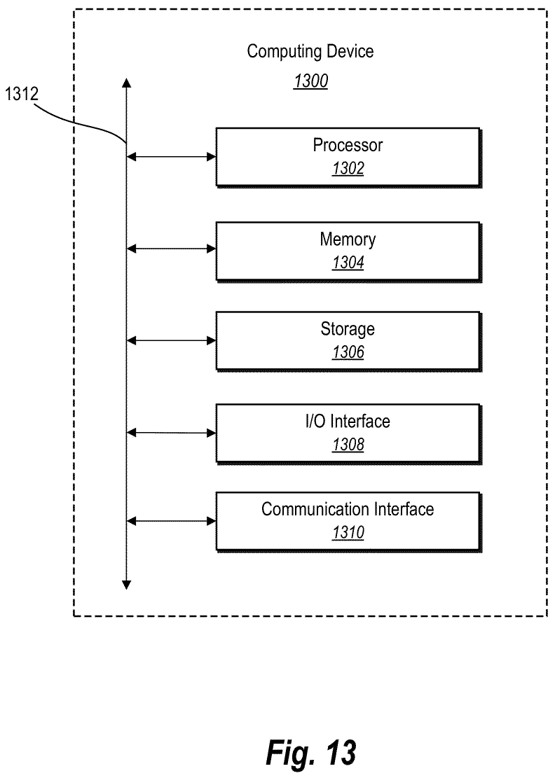

As shown in FIG. 1, the system environment 100 also includes the support terminal 110. The support terminal 110 may comprise a computing device (e.g., an agent client device associated with an agent), such as those described below in relation to FIG. 13. For example, the support terminal 110 may comprise one or more personal computers, laptop computers, mobile devices, mobile phones, tablets, special purpose computers, televisions, or other computing devices. As shown, in some embodiments, the support terminal 110 can also include the customer support system 114 (or a portion of the customer support system 114) and the video obscuring system 102 (or a portion of the video obscuring system 102). Indeed, in one or more embodiments, the support terminal 110 can execute or implement the customer support system 114. In some embodiments, the support terminal 110 executes or implements all features of the customer support system 114. In some embodiments, however, the support terminal 110 executes or implements a subset of the features of the customer support system 114. For example, the support terminal 110 can implement a first subset of features of the customer support system 114 and the server(s) 104 can implement a second subset of features of the customer support system 114 (which may, or may not, overlap with the first subset of features).

Additionally, in one or more embodiments, the administrator client device 120 provides an interface by which an administrator (e.g., via the administrator application 122) can control various settings associated with the video obscuring system 102. For example, the video obscuring system 102 can provide administrative settings to the administrator client device 120 for establishing settings associated with digital video communications. To illustrate, the administrative settings can cause the video obscuring system 102 to enable or disable digital video communications for a particular device (e.g., the support terminal 110 or the client device 106) or obscuring digital video streams at a particular device (e.g., the support terminal 110).

In one or more embodiments, the client device 106 and/or the administrator client device 120 includes a client device that allows a user of the device to receive and interact with content (e.g., display elements). For example, the client device 106 or the administrator client device 120 can include a smartphone, a tablet, a desktop, a computer, a laptop computer, or another electronic device. The client device 106 can include one or more applications (e.g., the client application 116 or the administrator application 122) that allow the user to receive and interact with content. For example, the client application 116 or the administrator application 122 can include a software application installed on the client device 106 or administrator client device 120, respectively. Additionally, or alternatively, the client application 116 or the administrator application 122 can include a software application hosted on the server(s) 104, which may be accessed by the client device 106 or the administrator client device 120, respectively, through another application, such as a web browser.

In one or more embodiments, the server(s) 104 include a variety of computing devices, including those described below with reference to FIG. 13. For example, the server(s) 104 include one or more servers for storing and processing data associated with digital images. In some embodiments, the server(s) 104 also include a plurality of computing devices in communication with each other, such as in a distributed storage environment. In some embodiments, the server(s) 104 include a content server. The server(s) 104 can also include an application server, a communication server, a web-hosting server, a social networking server, a digital content campaign server, or a digital communication management server.

As is also illustrated in FIG. 1, the system environment 100 may also include the Websocket server 108. The Websocket server 108 may generate, store, receive, and transmit any type of data, including a display element trigger (not shown) for presenting display elements to the client device 106. For example, the Websocket server 108 may receive and push a display element trigger sent from the support terminal 110 to the client device 106.

As shown in FIG. 1, the support terminal 110 can communicate with the client device 106 through the server(s) 104, the WebSocket server 108, and/or the peer-to-peer connection 118. For example, the support terminal 110 can communicate with the client device 106 using two or more channels of communication. To illustrate, the support terminal 110 can conduct a digital video communication with the client device 106 through the server(s) 104 or the peer-to-peer connection 118 while concurrently pushing display element triggers (and, possibly, the corresponding display elements) to the client device 106 through the WebSocket server 108.

In particular, the peer-to-peer connection 118 serves as a direct connection between the support terminal 110 and the client device 106. In one or more embodiments, the peer-to-peer connection 118 can serve to substitute for the server(s) 104. For example, after the server(s) 104 establishes the connection between the support terminal 110 and the client device 106, the support terminal 110 can subsequently establish the peer-to-peer connection 118 and conduct the digital video communication over that connection. As used herein, a peer-to-peer (P2P) connection is created when two or more client computing devices are connected and share resources without going through a separate server computing device (e.g., the server(s) 104). The peer-to-peer connection 118 can provide a solution to bandwidth limitations that restrict the maximum number of concurrent video streams possible through the server(s) 104. The peer-to-peer connections, where possible, maximize the number of possible simultaneous video calls.

In one or more embodiments, the server(s) 104 may first determine if the peer-to-peer connection 118 is available. For example, the peer-to-peer connection 118 may be unavailable due to limitations or the configuration of the hardware or software within the system environment 100. For example, video relays between client devices on restrictive networks and firewalls are often blocked. Network address translation limits the client device’s ability to have peer-to-peer connections. In one or more embodiments, the server(s) 104 detects when a peer-to-peer connection is not possible. If the server(s) 104 determines that the peer-to-peer connection 118 is not available, then the server(s) 104 may maintain (or reroute) the connection for the digital video communication. In an alternative embodiment, the server(s) 104 may maintain the connection with a client device whether or not the peer-to-peer connection 118 is available.

As mentioned, the customer support system 114 can be implemented in whole, or in part, by the individual elements of the system environment 100. Although FIG. 1 illustrates the customer support system 114 being implemented by the server(s) 104 and/or the support terminal 110, it will be appreciated that one or more components of the customer support system 114 can be implemented in a variety of the components of the system environment 100. For example, one or more components of the customer support system 114 can be implemented by a client device. For example, one or more of the components of the customer support system 114 can be implemented by the administrator client device 120.

Furthermore, although the system environment 100 of FIG. 1 is depicted as having a particular number of components, the system environment 100 can have any number of additional or alternative components (e.g., any number or servers, Websocket servers, support terminals, client devices, or other components in communication with the customer support system 114 via the network 112). Additionally, the video obscuring system 102 can be implemented in one or more additional systems for obscuring digital video streams between a plurality of client devices of users associated with the additional system(s) (e.g., instead of digital video communications involving the support terminal 110 via the customer support system 114). Similarly, although FIG. 1 illustrates a particular arrangement of the server(s) 104, the network 112, the Websocket server 108, the support terminal 110, and the client device 106, various additional arrangements are possible.

The server(s) 104, the network 112, the Websocket server 108, the support terminal 110, the client device 106, and/or the administrator client device 120 may be communicatively coupled with each other either directly or indirectly (e.g., through the network 112 as discussed in greater detail below in relation to FIG. 13). Moreover, the server(s) 104, the Websocket server 108, the support terminal 110, the client device 106, and/or the administrator client device 120 may include a variety of computing devices (including one or more computing devices as discussed in greater detail with relation to FIG. 13).

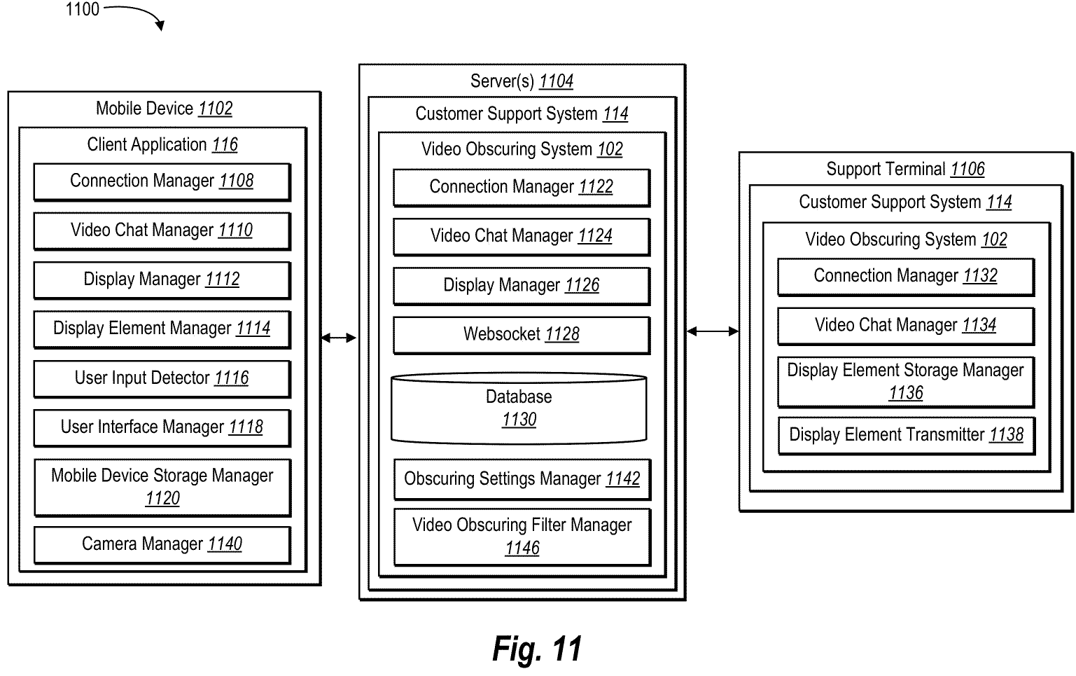

Additionally, as shown in FIG. 1, the system environment 100 includes the network 112. The network 112 enables communication between components of the system environment 100. In one or more embodiments, the network 112 may include the Internet or World Wide Web. Additionally, the network 112 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the support terminal 110, the Websocket Server 108, the client device 106, and the administrator client device 120 communicate via the network using one or more communication platforms and technologies suitable for transporting data and/or communication signals, including any known communication technologies, devices, media, and protocols supportive of data communications, examples of which are described with reference to FIG. 11.

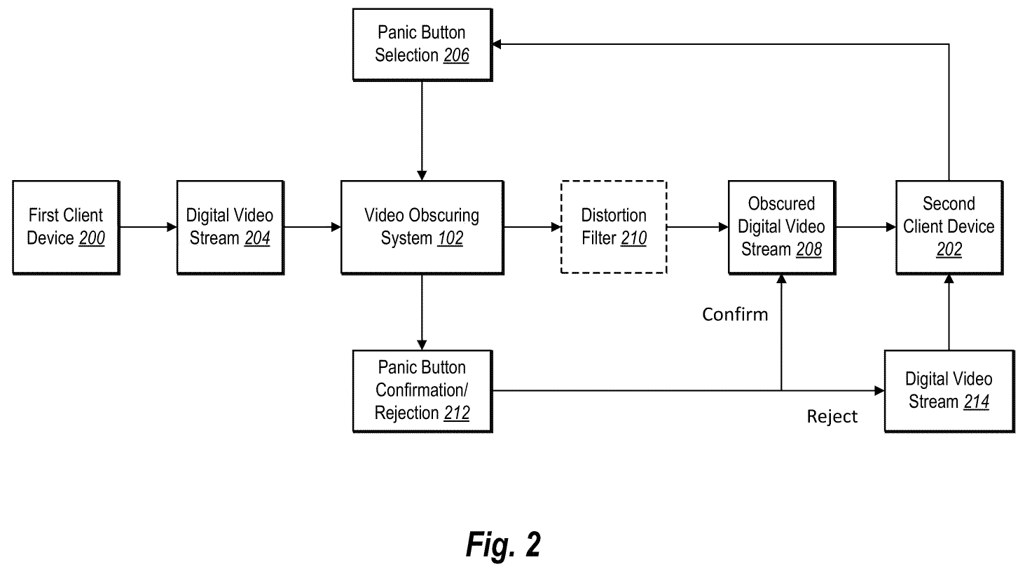

As mentioned, the video obscuring system 102 improves safety, security, and flexibility in digital video communications by obscuring digital video streams based on a user’s blur settings upon initiating a digital video communication. FIG. 2 illustrates an overview diagram of the video obscuring system 102 obscuring a digital video stream during an ongoing digital video communication. In particular, the video obscuring system 102 obscures the digital video stream in response to selection of an option to obscure the digital video stream while maintaining a connection corresponding to the digital video communication.

For example, FIG. 2 illustrates that a first client device 200 engages in a digital video communication with a second client device 202. Specifically, in one or more embodiments, the digital video communication between the first client device 200 and the second client device 202 involves at least the first client device 200 providing digital video to the second client device 202. In additional embodiments, the digital video communication also includes the second client device 202 providing digital video to the first client device 200. Additionally, the digital video communication can include a communication with the aid of another system or device (e.g., the server(s) 104 of FIG. 1) or via a peer-to-peer connection.

In connection with providing digital video from the first client device 200 to the second client device 202 upon initiating a digital video communication, FIG. 2 illustrates that the first client device 200 outputs a digital video stream 204. In one or more embodiments, the digital video stream 204 includes digital video captured by the first client device 200. For example, the first client device 200 can include a digital camera (e.g., a smartphone camera) for capturing video of a user of the first client device 200. Additionally, the first client device 200 can generate the digital video stream 204 for providing a real-time (e.g., “live”) video capture of the user of the first client device 200 during the digital video communication for presenting at the second client device 202.

As illustrated in FIG. 2, the video obscuring system 102 receives the digital video stream 204 from the first client device 200. For example, the video obscuring system 102 operates on a server connected to the first client device 200 and the second client device 202 to receive the digital video stream 204 in connection with facilitating the digital video communication. Alternatively, the video obscuring system 102 operates at the second client device 202 to receive the digital video stream 204 for the digital video communication.

In one or more embodiments, the video obscuring system 102 receives a request to obscure the digital video stream 204 at the second client device 202. For example, FIG. 2 illustrates that the video obscuring system 102 receives a panic button selection 206 (e.g., a selection of a graphical user interface element) indicating the request to obscure the digital video stream 204. To illustrate, the second client device 202 can provide the panic button selection 206 to the video obscuring system 102 while the digital video communication is ongoing (e.g., while the digital video stream 204 is presented at the second client device 202).

According to one or more embodiments, after receiving the panic button selection 206, the video obscuring system 102 obscures the digital video stream 204 at the second client device 202 during the digital video communication. For example, FIG. 2 illustrates that the video obscuring system 102 provides an obscured digital video stream 208 for display at the second client device 202. In some embodiments, the video obscuring system 102 provides the obscured digital video stream 208 by blocking display of the digital video stream 204 at the second client device 202. To illustrate, the video obscuring system 102 can black-out or otherwise hide/cover presentation of the digital video stream 204 at the second client device 202 during the digital video communication. The video obscuring system 102 can also prevent presentation of a digital audio stream corresponding to the digital video stream 204 at the second client device 202.

Alternatively, the video obscuring system 102 can prevent the second client device 202 from receiving the digital video stream 204 during the digital video communication. In particular, a server that receives the digital video stream 204 from the first client device 200 can continue receiving the digital video stream 204 but stop providing the digital video stream 204 to the second client device 202. Accordingly, the video obscuring system 102 can (at least temporarily) stop sending data associated with a digital video communication to the second client device 202 in response to the panic button selection 206.

In alternative embodiments, the video obscuring system 102 provides the obscured digital video stream 208 at the second client device 202 by applying a distortion filter 210 to the digital video stream 204 resulting in the obscured digital video stream 208. For instance, the video obscuring system 102 can generate the distortion filter 210 based on one or more distortion settings indicating a type and/or degree of distortion. To illustrate, the video obscuring system 102 can generate a blur filter for blurring details based on blur settings that indicate a degree of blur. The video obscuring system 102 can then apply the blur filter (or other distortion filter) to the digital video stream 204 to generate the obscured digital video stream 208.

Although not shown in FIG. 2, in one or more additional embodiments, the video obscuring system 102 also obscures a digital video stream from the second client device 202 at the first client device 200. Specifically, in response to receiving the panic button selection 206, the video obscuring system 102 can apply a distortion filter or otherwise obscure the digital video stream from the second client device 202 at the first client device 200. Thus, a user of the second client device 202 can prevent a user of the first client device 200 from viewing a digital video stream from the second client device 202 by selecting the option to obscure the digital video stream 204 from the first client device 200.

Furthermore, in one or more embodiments, the video obscuring system 102 requests a confirmation of the panic button selection 206. To illustrate, the video obscuring system 102 can provide a request to the second client device 202 to confirm or reject the panic button selection 206 to verify that a user of the second client device 202 intended to request to obscure the digital video stream 204. In some instances, a user may accidentally select an option to obscure a digital video stream. Accordingly, the request to confirm/reject the selection of the option provides the user the opportunity to correct an erroneous selection.

In response to a confirmation of the panic button selection 206, the video obscuring system 102 can continue obscuring the digital video stream 204 at the second client device 202. Specifically, the video obscuring system 102 can continue providing the obscured digital video stream 208 in response to a response confirming the intent of the user of the second client device 202 to obscure the digital video stream 204. For example, the video obscuring system 102 can continue applying a distortion filter to the digital video stream 204 or preventing the digital video stream 204 at the second client device 202.

In some embodiments, the video obscuring system 102 also terminates a connection corresponding to the digital video communication in response to the confirmation. For instance, the video obscuring system 102 terminates the connection between the first client device 200 and the second client device 202 that facilitates transmission of data (e.g., digital video streams, digital audio streams) between the client devices. After terminating the connection, the second client device 202 can no longer receive data from the first client device 200 (e.g., the digital video stream 204) and vice-versa.

Alternatively, in response to a rejection of the panic button selection 206, the video obscuring system 102 can resume displaying the digital video stream 204 at the second client device 202. In particular, the video obscuring system 102 can determine that the panic button selection 206 was accidental (or intended to be temporary). The video obscuring system 102 can then restore the digital video stream 204 for presentation at the second client device 202 for resuming the ongoing digital video communication involving the first client device 200 and the second client device 202.

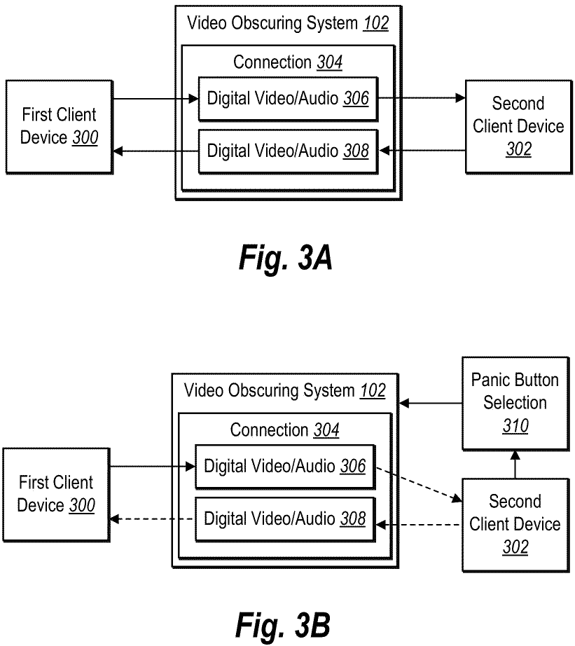

FIGS. 3A-3B illustrate additional detail associated with obscuring one or more digital video streams during a digital video communication. Specifically, as illustrated in FIGS. 3A-3B, a first client device 300 and a second client device 302 can be involved in a digital video communication. In one or more embodiments, in connection with initiating the digital video communication between the first client device 300 and the second client device 302, the video obscuring system 102 (or another system) can establish a connection 304 between the first client device 300 and the second client device 302. As mentioned previously, the connection 304 provides a communication channel by which the client devices can transmit data to each other.

In at least some embodiments, as illustrated in FIG. 3A, the video obscuring system 102 receives first digital video/audio 306 from the first client device 300 during the digital video communication via the connection 304. Additionally, the video obscuring system 102 receives second digital video/audio 308 from the second client device 302 during the digital video communication via the connection 304. The video obscuring system 102 can then provide the first digital video/audio 306 received from the first client device 300 to the second client device 302 and the second digital video/audio 308 received from the second client device 302 to the first client device 300 as part of the ongoing digital video communication. Accordingly, the second client device 302 can display the first digital video/audio 306 and the first client device 300 can display the second digital video/audio 308.

During the digital video communication, a user involved in the digital video communication can interact with a client device to obscure content received from the other client device. Specifically, as illustrated in FIG. 3B, the second client device 302 can provide a request to the video obscuring system 102 to obscure content associated with the digital video communication (e.g., via a panic button selection 310). In response to receiving the panic button selection 310, the video obscuring system 102 can obscure one or more of the digital video/audio streams via the connection 304. More specifically, FIG. 3B illustrates that the video obscuring system 102 obscures the first digital video/audio 306 at the second client device 302 and obscures the second digital video/audio 308 at the first client device 300.

Additionally, the video obscuring system 102 further maintains the connection 304 between the first client device 300 and the second client device 302. For example, while the video obscuring system 102 obscures digital video/audio at one or more of the client devices, the video obscuring system 102 maintains the connection 304. The video obscuring system 102 can thus continue receiving the first digital video/audio 306 and the second digital video/audio 308 from the first client device 300 and the second client device 302, respectively, during the digital video communication.

As further mentioned previously, the video obscuring system 102 can terminate a connection corresponding to a digital video communication in response to confirming a request to obscure a digital video stream. Specifically, the video obscuring system 102 can confirm the panic button selection 310 with the second client device 302. In response to confirming the panic button selection 310, the video obscuring system 102 can terminate the connection 304 and stop receiving the digital video/audio from the respective client devices. Alternatively, in response to receiving a response rejecting the panic button selection 310, the video obscuring system 102 can resume transmitting the digital video/audio between the first client device 300 and the second client device 302.

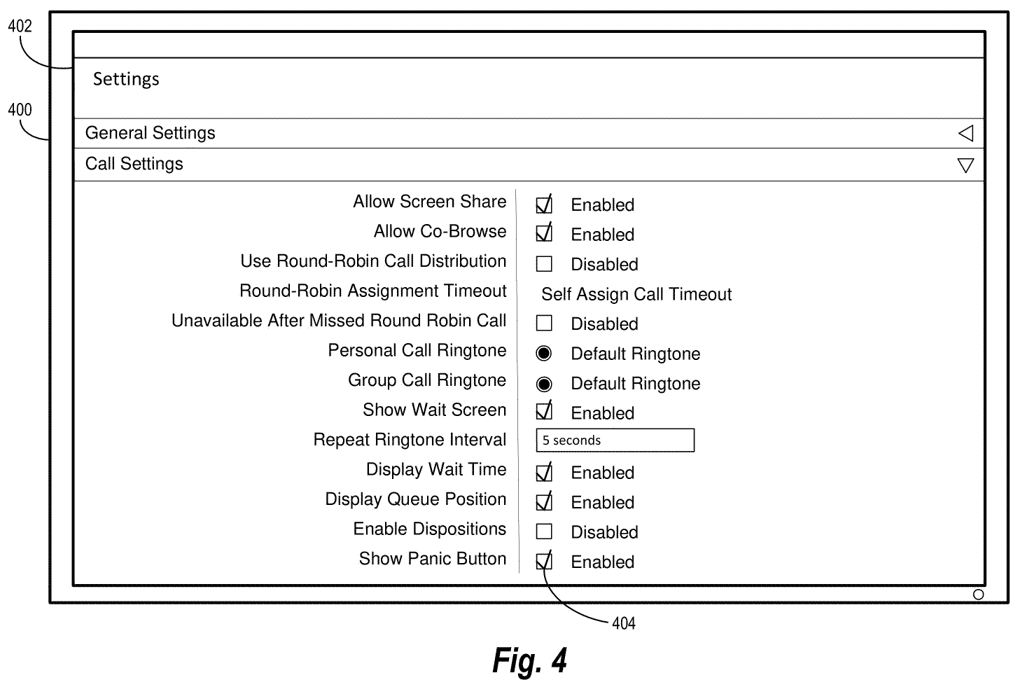

In one or more embodiments, the video obscuring system 102 can enable an option to obscure digital video streams at a client device based on input by a separate client device. In particular, FIG. 4 illustrates an administrator client device 400 that displays a graphical user interface 402 as part of an administrator application. As mentioned above, the video obscuring system 102 can provide the administrator client device 400 with administrative settings that allow an administrator user of the administrator client device 400 to control various aspects of digital video communications involving a plurality of client devices.

According to some embodiments, the video obscuring system 102 provides administrative settings to the administrator client device 400 based on an administrator user associated with the administrator client device 400 having a particular relationship with users of one or more additional client devices. For instance, the video obscuring system 102 can determine that the administrator user of the administrator client device 400 has administrative privileges in connection with a customer support system (e.g., the customer support system 114 of FIG. 1). Accordingly, the video obscuring system 102 can provide the administrator client device 400 with access to the administrative settings based on the administrator user having administrative privileges.

As part of the administrator client device 400 having access to the administrative settings, FIG. 4 illustrates that the administrator client device 400 displays a plurality of settings associated with digital video communications via the graphical user interface 402. In one or more embodiments, the administrative settings include, but are not limited to, settings that enable or disable operations at one or more client devices (e.g., agent client devices) in connection with digital video communications involving the one or more client devices. To illustrate, the video obscuring system 102 can provide a one or more settings that enable or disable screen sharing, user input controls, call distribution controls, media controls (e.g., ringtones, ring intervals), display controls (e.g., wait times, queue position), or other controls.

Furthermore, FIG. 4 illustrates that the video obscuring system 102 provides a panic button control 404 to enable a panic button (or another element) for a particular user. In one or more embodiments, in response to a selection of the panic button control 404 to enable the panic button for a user, the video obscuring system 102 causes a client device of the user to display (or otherwise activate) the panic button at the client device of the user during a digital video communication. Alternatively, in response to a selection of the panic button control 404 to disable the panic button for the user, the video obscuring system 102 causes the client device of the user to hide (or otherwise deactivate) the panic button at the client device of the user during a digital video communication.

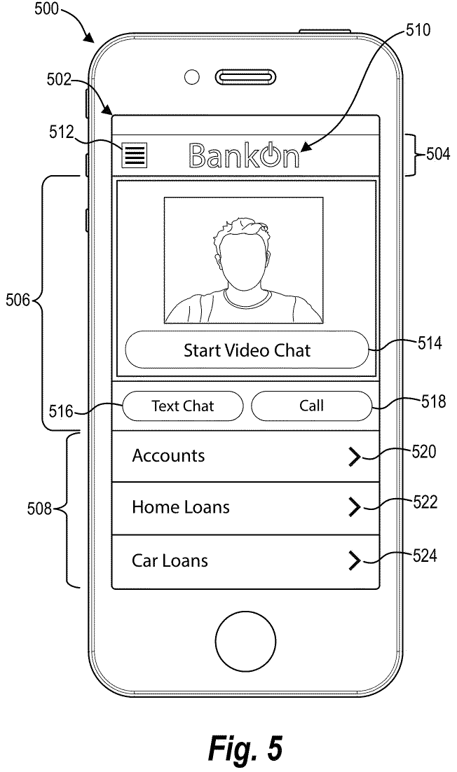

FIG. 5 illustrates a mobile device 500 displaying an application user interface 502 operable to allow a user to interact with a mobile application in accordance with one or more embodiments. For example, the mobile application can be associated with a business or other entity that allows a user to interact with the business/entity via the mobile application and/or perform one or more additional actions in connection with the business/entity (e.g., via a peer-to-business interaction). The application user interface 502 includes a heading portion 504, a customer support portion 506, and a navigation portion 508. In alternate embodiments, the application user interface 502 may include any other portions relevant to the mobile application.

The heading portion 504 of the application user interface 502 provides general information and options for the user. FIG. 5 illustrates the heading portion 504 providing a title 510 and a menu 512. The title 510 provides the title of the business but may alternatively provide the name of the mobile application or any other title deemed sufficient for the purposes of the mobile application. The menu 512 provides a drop-down menu with pre-selected options for interacting with the mobile application. For example, the drop-down menu provides the user with an option of logging into a user account or navigating to a home page of the mobile application. In one or more alternative embodiments, the menu 512 may be replaced with links in the heading portion 504 providing the user with similar options.

Customer support portion 506 provides an option to contact a support representative (or other agent associated with the business) to receive assistance. For example, a user who is unfamiliar with a mobile application may need assistance in finding information or performing a desired function. By way of illustration, in the context of a mobile banking application, the user may require help in applying for a loan, finding account balances, performing a check deposit, making a credit card payment, or interacting with the mobile application in another way.

As illustrated in FIG. 5, the customer support portion 506 includes multiple selectable buttons the user can select to contact a support representative. For example, the customer support portion 506 of FIG. 5 includes a video chat button 514, a text chat button 516, and a phone call button 518, which the mobile application may use to initiate a digital video communication, a text chat, or a phone call respectively. In response to a selection, the mobile device 500 sends a request to initiate a communications session of the type associated with the button. For example, by selecting the video chat button 514, the mobile device 500 sends a request to begin a digital video communication with a support representative.

Alternatively, the customer support portion 506 may include other selectable buttons to contact the support representative, such as an option to e-mail or send a voice-recorded message. It will also be appreciated that any number of selectable buttons may be present in the customer support portion 506 in any combination. To illustrate, the customer support portion 506 may include selectable buttons for digital video communication, text chat, phone call, and email message, or the customer support portion 506 may only include the video chat button 514.

The navigation portion 508 presents the user with quick navigational options. For example, the navigation portion 508 of FIG. 5 presents options to navigate to a page comprising information on accounts 520, information on home loans 522, or information on car loans 524. In one or more embodiments, other options deemed useful to the user may also be present.

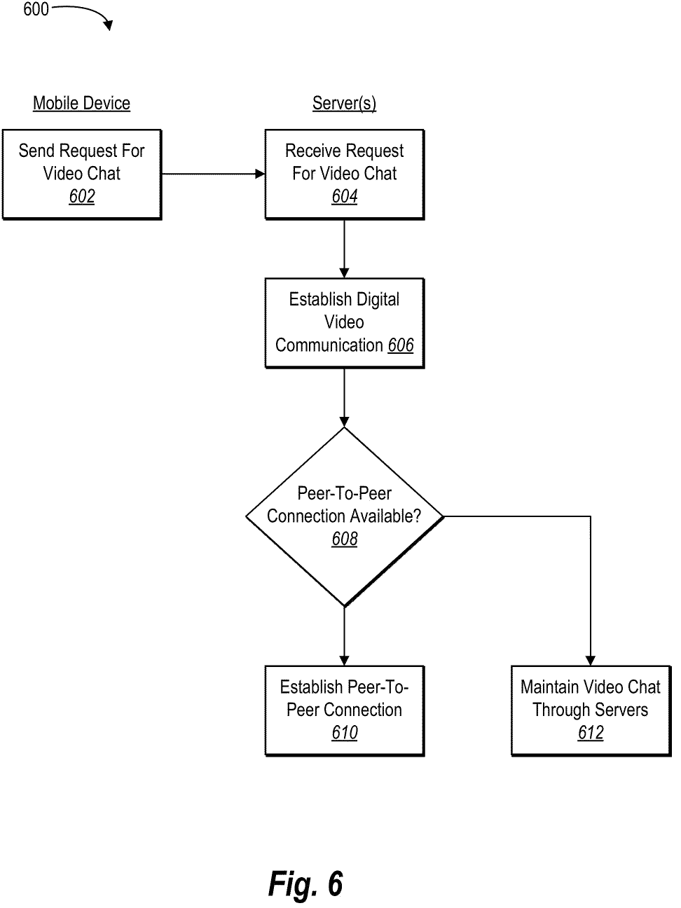

In one or more embodiments, the mobile device 500 establishes a digital video communication between a user client device (e.g., a mobile device) and an agent client device (e.g., a support terminal). FIG. 6 illustrates a flowchart of a series of acts 600 of initiating a digital video communication between a mobile device and a support terminal in accordance with one or more embodiments. Though FIG. 6 illustrates the series of acts 600 implemented in the context of a user using a mobile device, one or more embodiments involve the user utilizing another type of client device (e.g., desktop, laptop, tablet, etc.). In one or more embodiments, the series of acts 600 is performed in a hardware environment that includes the system environment 100. The series of acts 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the series of acts 600 includes an act 602 of sending, from a mobile device, a request to initiate a digital video communication. The request can initially be processed by a series of one or more servers, such as the server(s) 104 of FIG. 1. As discussed above, the server(s) 104 may contain a load balance server, a signaling server, and a STUN/TURN server. Alternatively, the request may be sent through a single server that performs the same functionality as the combination of servers. In particular, the act 602 includes sending a request from the mobile device to initiate a digital video communication between the mobile device and a support terminal.

Moreover, as illustrated in FIG. 6, the series of acts 600 also includes an act 604 of receiving the request to initiate a digital video communication. Furthermore, FIG. 6 illustrates that the series of acts 600 also includes an act 606 of establishing a digital video communication between the mobile device and a support terminal. In particular, the act 606 comprises establishing a first connection between the mobile device and the support terminal and conducting a digital video communication transmitted across the first connection. In particular, the first connection can comprise a connection established through the server(s) 104.

As shown in FIG. 6, the series of acts 600 also includes the act 608 of determining whether a peer-to-peer connection is available between the mobile device and the support terminal. In response to determining that a peer-to-peer connection is available, the series of acts 600 proceeds to the act 610 of establishing a peer-to-peer connection between the mobile device and the support terminal. In particular, the act 610 switches the digital video communication from being conducted via a connection through the server(s) 104 to a peer-to-peer connection (i.e., the peer-to-peer connection 118). In one or more embodiments, the act 610 may include severing the connection through server(s) 104 after the peer-to-peer connection has been established between the mobile device and the support terminal. One will appreciate in light of the disclosure herein that the use of a peer-to-peer connection to conduct the digital video communication can reduce system resources needed for the digital video communication, provide greater flexibility, and in some cases allow for quicker communication between the mobile device and the support terminal.

Alternatively, in response to determining that a peer-to-peer connection is not available, the series of acts 600 proceeds to the act 612 of maintaining the digital video communication through the server(s) 104. In one or more embodiments, the digital video communication may be maintained through the server(s) 104 whether or not a peer-to-peer connection is available.

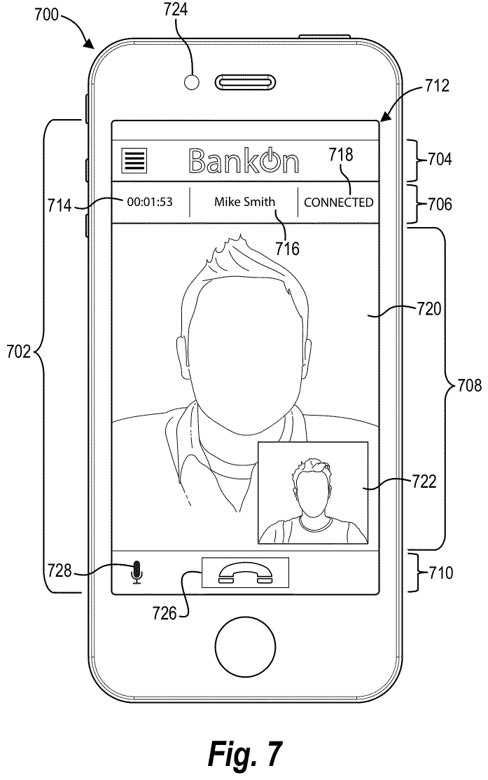

FIG. 7 illustrates a mobile device 700 displaying a video chat interface 702 after a digital video communication has been established between a mobile device and a support terminal. The video chat interface 702 includes a heading portion 704, a session information portion 706, a video chat display portion 708, and a session control portion 710. As illustrated in FIG. 7, the video chat interface 702 utilizes the entirety of the mobile device display screen 712. In one or more alternative embodiments, the video chat interface 702 utilizes less than the entirety of the mobile device display screen 712 in response to receiving a display element trigger from a support terminal after the digital video communication is established to present one or more display elements with the digital video communication.

As illustrated in FIG. 7, the session information portion 706 of the video chat interface 702 displays information regarding the digital video communication conducted between the mobile device and the support terminal. In particular, the session information portion 706 includes a time-keeping portion 714, a support representative identity portion 716, and a connection status portion 718. The time-keeping portion 714 displays the duration of the current digital video communication. The support representative identity portion 716 displays the name of the support representative engaging in the digital video communication. The connection status portion 718 displays the status of the connection between the mobile device and the support terminal. In one or more embodiments, the connection status portion 718 can indicate whether the digital video communication is being conducted via a peer-to-peer connection or not.

As illustrated in FIG. 7, the video chat display portion 708 includes a support representative display 720 and a mobile device user display 722. In particular, the support representative display 720 displays video content captured by the support terminal. The mobile device user display 722 displays video content captured by a camera 724 of the mobile device 700. As shown in FIG. 7, mobile device user display 722 is displayed in a lower right corner of the video chat display portion 708. Alternatively, the mobile device user display 722 may be displayed in another location of the video chat display portion 708. In one or more embodiments, the mobile device user display 722 may be relocated to another location in response to detecting a user interaction. For example, a user may select and, with a dragging motion, relocate the mobile device user display 722 to another location.

As further illustrated in FIG. 7, the session control portion 710 of the video chat interface 702 includes a session end option 726 and a microphone mute option 728. Alternatively, one or more embodiments may include other options, such as a record option to record the audio content, visual content, or both from the digital video communication.

In establishing a digital video communication between a client device and a support terminal, a customer support system (e.g., via the support terminal or a server) can send instructions to the client device to display the digital video communication concurrently with a display element. For example, a customer support system can send a display element trigger to the client device that causes the client device to partition its display into multiple panes and to display the digital video communication in one pane and the corresponding display element in another pane. In some embodiments, a customer support system (e.g., via the support terminal or a server) sends a separate display trigger, in addition to the display element trigger, to cause the client device to partition its display. To illustrate, in some embodiments, a display element trigger causes the device to retrieve, render, or otherwise obtain a corresponding display element and the display trigger separately causes the client device to partition its display so as to display the display element concurrently with the digital video communication.

In one or more embodiments, a display element includes a visualization of data and/or interactive elements displayable on a user interface. In particular, a display element includes a visual means for viewing information or performing a task displayable on a user interface. For example, a display element can include a signature pad, a video, a fillable digital form, a selectable option for accepting terms, a document, or an informational slide. A display element can further include an interactive button enabling a user to submit that a corresponding task has been completed. Accordingly, a client device can display a digital video communication with additional interactive display elements for performing one or more operations within a graphical user interface of a client application.

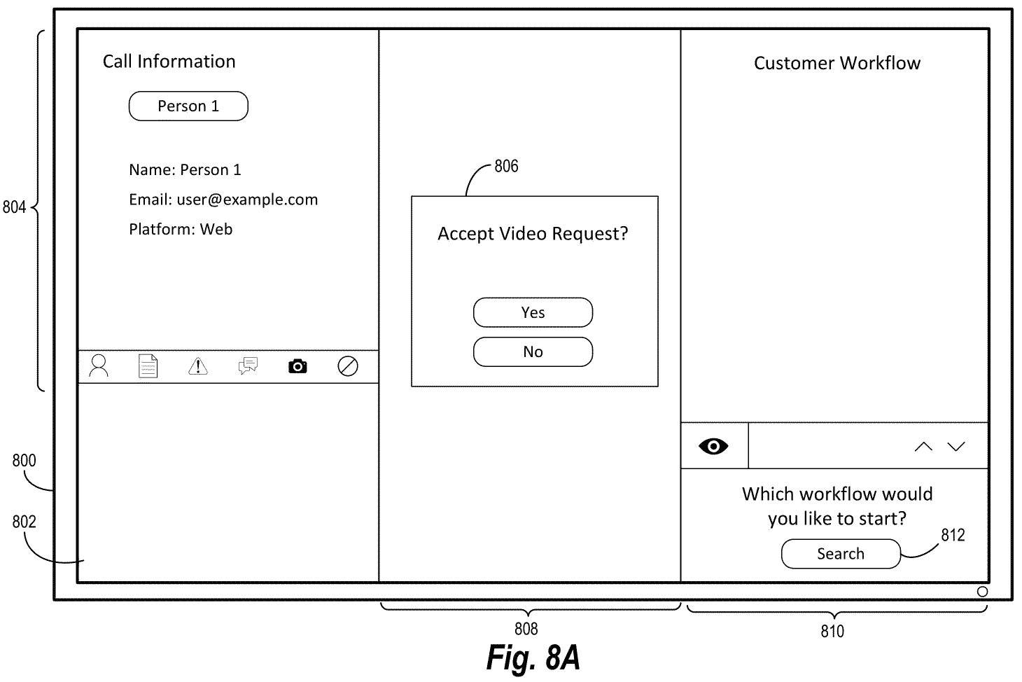

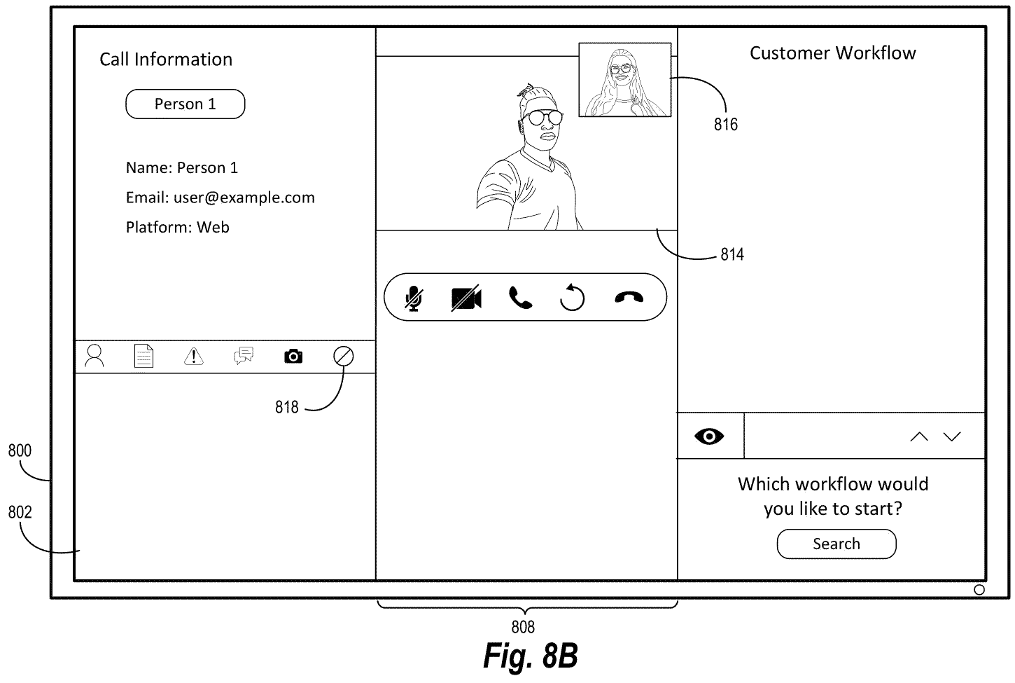

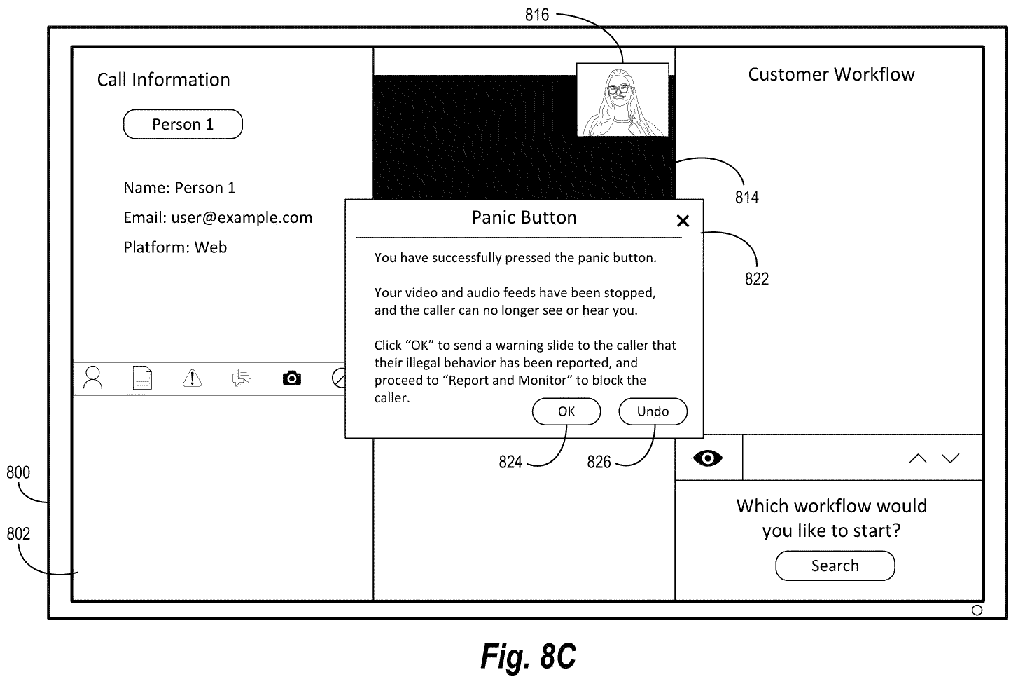

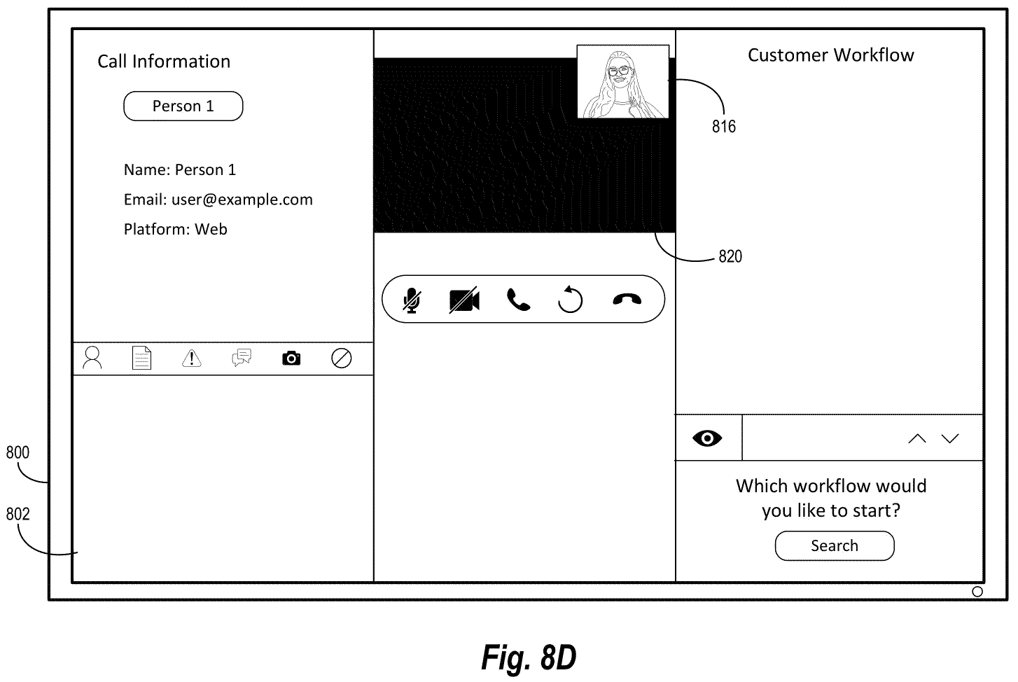

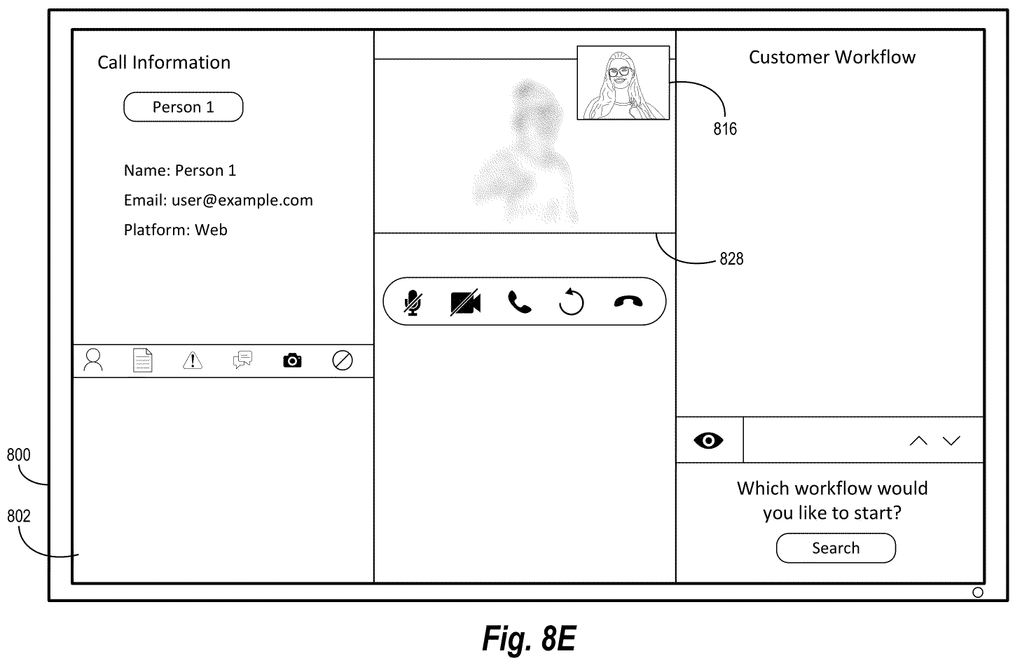

As mentioned, the video obscuring system 102 can obscure a digital video stream at a client device during an ongoing digital video communication involving the client device. FIGS. 8A-8E illustrate graphical user interfaces for conducting a digital video communication with one or more users and performing operations to assist the one or more users with one or more operations. In particular, FIGS. 8A-8E illustrate a sequence of graphical user interfaces in which the video obscuring system 102 initiates a digital video communication and presents a digital video stream of a first user (e.g., a customer) to a second user (e.g., an agent) at a client device of the second user. More specifically, FIGS. 8A-8E illustrate graphical user interfaces for initiating a digital video communication and obscuring a digital video stream during the digital video communication.

FIG. 8A illustrates a client device 800 displaying a graphical user interface 802 associated with a client application. In one or more embodiments, the client device 800 includes an agent client device associated with an agent of an entity. Additionally, the client application can include a software application for communicating with users associated with the entity (e.g., customers or potential customers) and aiding the users. In particular, the client application can include tools for communicating with users via various digital communications media and/or for performing operations to assist the users while communicating with the users.

In one or more embodiments, the client device 800 receives a request to initiate a digital video communication between the user of the client device 800 and a user of another client device. In response to the request, the client device 800 can obtain call information and display the call information within an information portion 804 of the graphical user interface 802. For example, the client device 800 can obtain a name, a username, contact information (e.g., email address), and a platform associated with the request (e.g., mobile application, web interface). As shown in FIG. 8A, the client device 800 can display the call information for a user of the other client device that requested the digital video communication.

In addition to displaying the call information within the information portion 804, the client device 800 can display a prompt 806 indicating options for the user to accept or reject a request to initiate a digital video communication. Specifically, in response to receiving the request, the client device 800 can display the prompt 806 within a video portion 808 of the graphical user interface 802. As illustrated in more detail in FIG. 8B and FIG. 8C, the client device 800 can display a digital video stream as part of a digital video communication within the video portion 808 after detecting a selection to accept the request.

Additionally, FIG. 8A illustrates that the client device 800 displays a workflow portion 810 including information and/or options associated with performing one of a plurality of available workflows. In one or more embodiments, the workflow portion 810 includes a workflow search 812 to search for a specific workflow in connection with a digital video communication. For example, after (or otherwise in connection with) accepting a request to initiate a digital video communication, the user can also select a workflow to initiate. The client device 800 can then present display elements corresponding to the selected workflow within the workflow portion 810. Accordingly, the client device 800 can provide tools for performing various operations associated with the selected workflow to provide information and/or assistance to requesting users involved in a digital video communication with the user of the client device 800.

FIG. 8B illustrates that the client device 800 presents digital video streams associated with a digital video communication initiated between two users. Specifically, the client device 800 receives a digital video stream 814 captured at a client device of a user requesting the digital video communication (e.g., at a client device of a customer). In one or more embodiments, the client device 800 receives the digital video stream 814 from a server including a customer support system or from the client device of the requesting user (e.g., in a peer-to-peer connection). The client device 800 can then display the digital video stream within the video portion 808 of the graphical user interface 802.

In one or more embodiments, the client device 800 also provides an additional digital video stream 816 including digital video of the user captured by the client device 800 (or by a video capture device associated with the client device 800). For instance, as illustrated in FIG. 8B, the client device 800 can display the additional digital video stream 816 as an overlay on top of a portion of the digital video stream 814. Alternatively, the client device 800 can display the additional digital video stream 816 in another area of the graphical user interface 802 such as below, above, or to the side of the digital video stream 814.

In connection with presenting a digital video stream at a client device during a digital video communication, the video obscuring system 102 can also provide an option to obscure the digital video stream during the digital video communication. For example, FIG. 8B illustrates that the video obscuring system 102 can provide a panic button 818 within the graphical user interface 802 during an ongoing digital video communication. Accordingly, the client device 800 displays the panic button 818 concurrently with the digital video stream 814 received from a separate client device involved in a digital video communication with the client device 800. To illustrate, the client device 800 can display the panic button 818 with one or more other user interface elements for performing one or more operations related to the digital video communication.

In one or more embodiments, as previously mentioned, the video obscuring system 102 can enable the panic button 818 at the client device 800 based on an administrative setting. For instance, in response to determining that an administrative setting established at an administrative device enables the panic button 818 for a user of the client device 800, the video obscuring system 102 can cause the client device 800 to display or otherwise activate the panic button 818 (e.g., make the panic button 818 selectable). Alternatively, in response to determining that the administrative setting disables the panic button 818 for the user of the client device 800, the video obscuring system 102 can cause the client device 800 to hide or otherwise deactivate the panic button 818 (e.g., make the panic button 818 not selectable). In some embodiments, the video obscuring system 102 can enable the panic button 818 for some digital video communications (e.g., with a first set of users or client devices) and disable the panic button 818 for other digital video communications (e.g., with a second set of users or client devices).

According to some embodiments, the video obscuring system 102 detects a selection of the panic button 818 at the client device 800. In particular, as discussed previously, a user of a client device can interact with the panic button 818 if the user determines that a digital video stream presented at the client device 800 includes inappropriate or offensive content. Thus, the client device 800 can detect an interaction by the user selecting the panic button 818 during an ongoing digital video communication.

In response to the selection of the panic button 818, the video obscuring system 102 can obscure the digital video stream 814. Specifically, FIG. 8C illustrates that the client device 800 displays an obscured digital video stream 820. For example, as previously mentioned, the video obscuring system 102 causes the client device 800 to display the obscured digital video stream 820 by preventing the client device 800 from displaying the digital video stream 814. To illustrate, the video obscuring system 102 hides the digital video stream 814 received from another client device within the graphical user interface 802 or blacks out the digital video stream 814, resulting in the obscured digital video stream 820 while maintaining the connection corresponding to the digital video communication. As further shown in FIG. 8C, the client device 800 may not obscure the additional digital video stream 816 captured by the client device 800.

In addition to obscuring the digital video in response to a selection of the panic button 818, the video obscuring system 102 can also request confirmation of the selection. For instance, as illustrated in FIG. 8C, the video obscuring system 102 provides a notification 822 requesting that the user of the client device 800 confirm or reject the selection of the panic button 818. To illustrate, the notification 822 can include a confirmation element 824 to confirm the selection of the panic button 818 and a rejection element 826 to reject the selection of the panic button 818. Although FIG. 8C illustrates that the client device 800 requests confirmation in an overlay covering a portion of the obscured digital video stream 820, the client device 800 can confirm the selection of the panic button 818 in any manner, such as by requiring the user to perform a specific input at the client device 800 (e.g., double-clicking the panic button 818).

In response to receiving a confirmation of the selection of the panic button 818, the video obscuring system 102 can continue obscuring the digital video stream 814. Specifically, FIG. 8D illustrates that client device 800 maintains the obscured digital video stream 820 within the graphical user interface 802. Thus, the video obscuring system 102 prevents the user of the client device 800 from viewing inappropriate or offensive content. In one or more embodiments, the video obscuring system 102 terminates the connection after receiving confirmation of the selection of the panic button 818. Accordingly, the video obscuring system 102 can prevent the client device 800 from receiving additional information from another client device involved in the digital video communication, and vice-versa.

Additionally, in some embodiments, the video obscuring system 102 performs one or more additional operations in connection with obscuring the digital video stream 814. To illustrate, the video obscuring system 102 can cause the client device 800 to further prompt the user (e.g., within a report interface) to report an additional user associated with the digital video stream 814 to a third-party system (e.g., law enforcement such as the Federal Bureau of Investigation’s Crime Complaint Center). In one or more embodiments, the video obscuring system 102 maintains the connection corresponding to the digital video communication while presenting the obscured digital video stream 820 and prior to presenting the prompt to report the additional user at the client device 800. Maintaining the connection can allow the client device 800 to send additional information to the additional client device (e.g., a notification of the report) before terminating the connection. Alternatively, the video obscuring system 102 terminates the connection prior to presenting the prompt to report the additional user.

FIG. 8E illustrates that the video obscuring system 102 can obscure a digital video stream by distorting the digital video stream. For example, the video obscuring system 102 can generate a distortion filter according to one or more distortion settings (e.g., a degree of distortion, a type of distortion). The video obscuring system 102 can then apply the distortion filter to the digital video stream 814 to generate and present a distorted digital video stream 828 at the client device 800. The distortion filter can include a blur filter, a warp filter, a pixelization filter, or other filter that obscures details of the digital video stream 814 for display at the client device 800.

While FIGS. 8A-8E illustrate that the video obscuring system 102 can obscure a single digital video stream involved in a digital video communication with a user of a client device, the video obscuring system 102 can obscure any number of digital video streams simultaneously or individually. For example, the video obscuring system 102 can obscure one or more digital video streams involved in a digital video communication involving three or more client devices with three or more digital video streams. Additionally, the video obscuring system 102 can obscure one or more digital video streams added to a digital video communication after initiating the digital video communication.

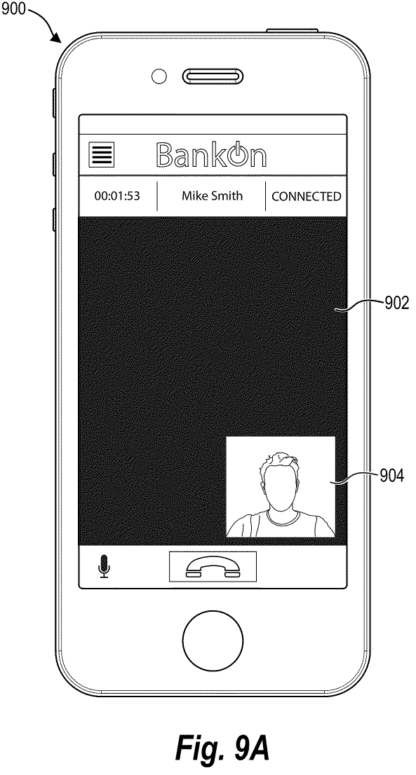

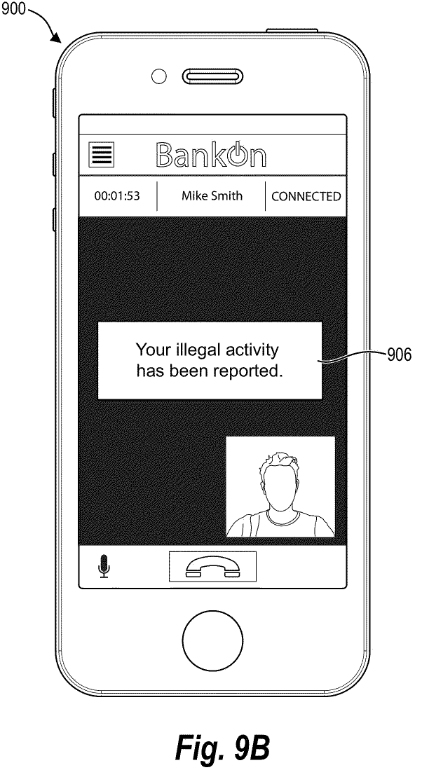

FIGS. 9A-9B illustrate graphical user interfaces of a client device associated with a digital video stream obscured at an additional client device. For example, FIGS. 9A-9B illustrate a client device 900 associated with a user (e.g., consumer) that requests a digital video communication with another user (e.g., an agent). In particular, the client device 900 captures a digital video stream that includes inappropriate or offensive content to provide to the additional client device.

In one or more embodiments, in response to receiving a selection of an option to obscure a digital video stream received from the client device 900, the video obscuring system 102 can also obscure content at the client device 900. For instance, the video obscuring system 102 can obscure a digital video stream received from the additional client device of the user corresponding to the selected option to obscure a digital video stream. FIG. 9A illustrates that the client device 900 displays an obscured digital video stream 902 by preventing the client device 900 from displaying the digital video stream received from the additional client device. In some embodiments, the video obscuring system 102 also obscures a digital audio stream received from the additional client device.

The client device 900 can further continue displaying a digital video stream 904 captured by the client device 900. For instance, the digital video stream 904 can include captured video of the user of the client device 900 and may include the inappropriate or offensive content that resulted in the request to obscure the digital video stream 904 at the additional client device. By presenting the obscured digital video stream 902 (and in some cases an obscured digital audio stream) without presenting a notification of the action to obscure digital content at the client device 900, the video obscuring system 102 can simulate an accidental disruption in the connection corresponding to the digital video communication.

After the video obscuring system 102 receives a confirmation of the selection to obscure a digital video stream, the video obscuring system 102 can also provide a notification to the client device 900. For example, as illustrated in FIG. 9B, the video obscuring system 102 can cause the client device 900 to display a report notification 906. To illustrate, the client device 900 can display the report notification 906 as an overlay, a slide, or otherwise in connection with the digital video communication (e.g., within a graphical user interface of a client application for the digital video communication). In one or more embodiments, the report notification 906 includes an indication that the content of the digital video stream 904 was reported to a third-party system (e.g., law enforcement). The report notification 906 may additionally or alternatively include a reason for reporting the content or for obscuring the content of the digital video stream 904 at the additional client device.

Furthermore, in one or more embodiments, the video obscuring system 102 can utilize information associated with a report to prevent a user from engaging in future digital video communications. For example, in response to a report of a digital video stream, the video obscuring system 102 can obtain information associated with a client device (e.g., the client device 900) including, but not limited to, a device location (e.g., IP address), a device identifier, or a user account associated with the client device. The video obscuring system 102 can then block the client device or user account utilizing the obtained information from engaging in digital video communications with a specific client device or with a plurality of client devices.

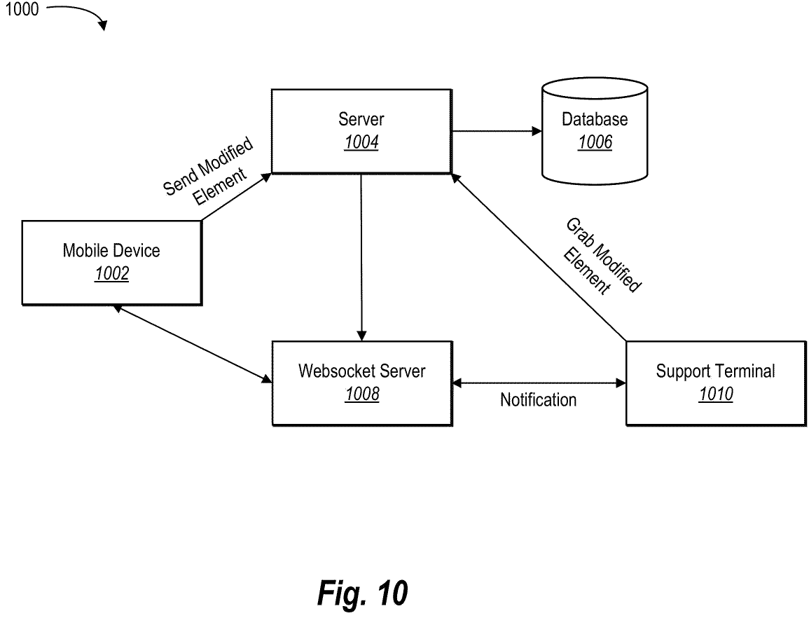

As mentioned previously, the video obscuring system 102 can obscure digital video streams in digital video communications along with display elements for performing various workflows associated with the digital video communications. Accordingly, in connection with initiating digital video communications, some embodiments of the video obscuring system 102 (or a customer support system including the video obscuring system 102) can provide the ability to modify display elements across a plurality of client devices in one or more workflows. FIG. 10 illustrates an example implementation of a system 1000 for sending a modified display element to a support terminal. In one or more embodiments, the system 1000 comprises components used in the system environment 100 of FIG. 1, and the system environment 100 can perform the same operations as the system 1000. In other words, the customer support system 114 of FIG. 1 operates within the system environment 100 to implement the system 1000. As illustrated in FIG. 10, the system 1000 comprises a mobile device 1002, a server 1004, a database repository 1006, a WebSocket server 1008, and a support terminal 1010.

The system 1000 establishes a connection between the mobile device 1002 and the database repository 1006 through the server 1004. In one or more embodiments, the connection is a third connection different from a first connection used to establish a digital video communication between the mobile device 1002 and the supporter terminal 1010 and different from a second connection used to enable the support terminal 1010 to push display elements to the mobile device 1002. The server 1004 enables the mobile device 1002 to securely transmit a modified display element to the database repository 1006. As illustrated in FIG. 10, the server 1004 is a single server. Alternatively, the third connection may be made through a series of servers. Because the system 1000 can provide the display elements and modified display elements via one or more connections separate from a connection used to establish the digital video communication, the system 1000 can securely and separately maintain the information from the digital video communication and display elements.

After receiving a modified display element, in one or more embodiments, the support terminal 1010 may grab the modified element from the server 1004 or by otherwise communicating with the server 1004, as illustrated in FIG. 10. In one or more alternative embodiments, the server 1004 forwards the modified display element to the database repository 1006 and sends a notification to the support terminal 1010 through the WebSocket server 1008. In one or more alternative embodiments, the notification may be sent to the support terminal 1010 directly from the mobile device 1002. The notification indicates that the database repository 1006 has received the modified display element and provides a location of the element within the database repository 1006 so the support terminal 1010 may grab the modified element. Additionally, or alternatively, the notification may include a link to the location of the modified display element, enabling the support terminal 1010 to quickly acquire the modified element.

The database repository 1006 may comprise a service that allows for the deposit and retrieval of electronic files. For example, the database repository 1006 may be an electronic drop box, email service, or other cloud-based technology that allows electronic file sharing.

Though not explicitly illustrated in FIG. 10, one or more embodiments use the system 1000 to provide notifications and display elements to the mobile device 1002. For example, the server 1004 can send a notification of a task to the mobile device 1002 (e.g., through the WebSocket server 1008). If the user indicates acceptance of the task indicated by the notification, the server 1004 can then retrieve the display element that corresponds to the task from the database repository 1006 and provide the display element to the mobile device 1002.

As shown by FIG. 10, the system 1000 can utilize cloud hosting (i.e., the database can comprise one or more cloud-based servers). This type of cloud hosting allows for flexibility and scalability. New instances of servers can be created quickly and efficiently to ensure the system scales the use of the application as adoption rates increase. Thus, embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

Turning now to FIG. 11, additional detail will be provided regarding components and capabilities of one embodiment of the present invention comprising the system environment 100 as well as the system 1000. In particular, FIG. 11 illustrates an embodiment of an exemplary system 1100. As shown, the system 1100 may include, but is not limited to, a mobile device 1102, a server(s) 1104, and a support terminal 1106. Moreover, as shown, the mobile device 1102 includes, but is not limited to, a connection manager 1108, a video chat manager 1110, a display manager 1112, a display element manager 1114, a user input detector 1116, a user interface manager 1118, a mobile device storage manager 1120, and a camera manager 1140. Additionally, as shown in FIG. 11, the server(s) 1104 includes the video obscuring system 102 (e.g., in the customer support system 114), which further includes, but is not limited to, a connection manager 1122, a video chat manager 1124, a display manager 1126, a WebSocket 1128, a database 1130, an obscuring settings manager 1142, and a video obscuring filter manager 1146. Though not shown in FIG. 11, it will be appreciated that the support terminal 1106 can include the obscuring settings manager 1142, the video obscuring filter manager 1146, and/or one or more other components of the video obscuring system 102), as discussed above. Furthermore, as shown in FIG. 11, the support terminal 1106 includes, but is not limited to, a connection manager 1132, a video chat manager 1134, a display element storage manager 1136, and a display element transmitter 1138.

As just mentioned, and as illustrated in FIG. 11, the mobile device 1102 includes the connection manager 1108. The connection manager 1108 searches for, detects, identifies, accepts, establishes, monitors, and maintains various types of connections. In particular, the connection manager 1108 establishes and maintains one or more connections between the mobile device 1102 and another device, such as the support terminal 1106. For example, when establishing a digital video communication between the mobile device 1102 and the support terminal 1106, the connection manager 1108 will establish and maintain a peer-to-peer connection through the duration of a digital video communication.

As mentioned, and as illustrated in FIG. 11, the mobile device 1102 also includes the video chat manager 1110. The video chat manager 1110 initiates, provides for display, and maintains a digital video communication between the mobile device 1102 and another device, such as the support terminal 1106. In particular, the video chat manager 1110 operates in conjunction with the connection manager 1108 to establish and maintain a digital video communication between the mobile device 1102 and another device, such as the support terminal 1106.

Additionally, the video chat manager 1110 operates in conjunction with a number of user input/output devices, including, but not limited to cameras, microphones, display screens, touchscreens, and keypads.

As mentioned, and as illustrated in FIG. 11, the mobile device 1102 also includes the display manager 1112. The display manager 1112 maintains and changes a display presented on the mobile device 1102. In particular, the display manager 1112 works in conjunction with the user input detector 1116 to change a display of the mobile device in response to detecting a user interaction. Additionally, the display manager 1112 works in conjunction with the user interface manager 1118 to display a graphical user interface.

The display manager 1112 also changes the display of the mobile device 1102 in response to receiving triggering code through a connection to another device. For example, the display manager 1112 may receive triggering code over a connection. In response to receiving the triggering code, the display manager 1112 can divide the display of the mobile device 1102 into multiple panes, enabling the mobile device 1102 to display multiple display items within the multiple panes. As referred to herein, a “display item” refers to a visual component (e.g., character, image, video, or user interface). For example, the mobile device 1102 may be able to display separate mobile applications in the multiple panes or the mobile device may display a digital video communication in one pane and a display element in another.

Additionally, the display manager 1112 may modify the size of the multiple panes according to the needs of the items displayed within those panes. In particular, the display manager 1112 may increase the size of a pane if the display item within the pane requires more display space.

As mentioned, and as illustrate in FIG. 11, the mobile device 1102 also includes the display element manager 1114. The display element manager 1114 receives, sends, and provides for display elements. In particular, the display element manager 1114 operates in conjunction with the display manager 1112 to display a display element on the mobile device 1102. In one or more embodiments, the display element manager 1114 can render display elements.

Additionally, the display element manager 1114 modifies and maintains display elements. In particular, the display element manager operates in conjunction with the user input detector 1116 to detect a user input. In response to detecting a user input, the display element manager 1114 modifies the display element in accordance to the particular user interaction.

As mentioned, and as illustrated in FIG. 11, the mobile device 1102 also includes the user input detector 1116. The user input detector 1116 detects, identifies, monitors, receives, processes, captures, and/or records various types of user input. For example, the user input detector 1116 detects one or more user interactions with respect to a user interface. As referred to herein, a “user interaction” refers to conduct performed by a user (or a lack of conduct performed by a user) to control the function of a computing device. “User input,” as used herein, refers to input data generated in response to a user interaction.

The user input detector 1116 operates in conjunction with a number of user input devices (in isolation or in combination), mouse devices, keyboards, track pads, or stylus devices. The user input detector 1116 detects and identifies various types of user interactions with user input devices, such as select events, drag events, scroll events, and so forth. For example, the user input detector 1116 detects one or more touch gestures (e.g., swipe gestures, tap gestures, pinch gestures, or reverse pinch gestures) from a user that forms a user interaction.

The user input detector 1116 communicates with, and thus detects user input with respect to, a variety of programs, applications, plug-ins, operating systems, user interfaces, or other implementations in software or hardware.

As mentioned, and as illustrated in FIG. 11, the mobile device 1102 also includes the user interface manager 1118. The user interface manager 1118 provides, manages, and/or controls a graphical user interface (or simply “user interface”) for use with the system 1100. In particular, the user interface manager 1118 can facilitate presentation of information by way of an external component of the mobile device 1102. For example, the user interface manager 1118 can display a user interface by way of a display screen associated with the mobile device 1102. The user interface may be composed of a plurality of graphical components, objects, and/or elements that allow a user to perform a function. The user interface manager 1118 presents, via the mobile device 1102, a variety of types of information, including text, images, video, audio, characters, or other information. Moreover, the user interface manager 1118 provides a variety of user interfaces specific to a variety of functions, programs, applications, plug-ins, devices, operating systems, and/or components of the mobile device 1102.

The user interface manager 1118 can provide a user interface with regard to a variety of operations or applications. For example, the user interface manager 1118 provides a user interface that facilitates selecting, identifying, searching, or downloading digital files. Similarly, the user interface manager 1118 can generate a user interface that facilitates managing, editing, modifying, downloading, uploading, or sending digital images. Additional details with respect to various example user interface elements are described throughout with regard to various embodiments containing user interfaces.

In addition, as illustrated in FIG. 11, the mobile device 1102 also includes the mobile device storage manager 1120. The mobile device storage manager 1120 maintains data for the system 1100. The mobile device storage manager 1120 can maintain data of a type, size, or kind, as necessary to perform the functions of the system 1100.

Additionally, as illustrated in FIG. 11, the mobile device 1102 also includes the camera manager 1140. The camera manager 1140 controls operation of one or more cameras of the mobile device 1102. For example, the camera manager 1140 can activate a camera of the mobile device 1102 and capture images using the camera of the mobile device 1102.

Furthermore, as illustrated in FIG. 11, the server(s) 1104 includes the connection manager 1122. The connection manager 1122 searches for, detects, identifies, accepts, establishes, monitors, and maintains various types of connections. In particular, the connection manager 1122 establishes and maintains one or more connections between devices. For example, the connection manager 1122 may establish a connection between the mobile device 1102 and the support terminal 1106.

As mentioned, and as illustrated in FIG. 11, the server(s) 1104 also includes the video chat manager 1124. The video chat manager 1124 establishes, receives, transmits, and maintains a digital video communication between multiple devices. For example, the video chat manager 1124 may establish and maintain a digital video communication between the mobile device 1102 and another device, such as the support terminal 1106. In particular, the video chat manager 1124 operates in conjunction with the connection manager 1122 to establish and maintain a digital video communication across a connection maintained by server(s) 1104.

As mentioned, and as illustrated in FIG. 11, the server(s) 1104 also includes the display manager 1126. The display manager 1126 receives and transmits items for display on devices. In particular, the display manager 1126 can transmit items sent from one device to another device. For example, the display manager 1126 can transmit a display element sent from the support terminal 1106 to be displayed on the mobile device 1102.

As mentioned, and as illustrated in FIG. 11, the server(s) 1104 also includes the WebSocket 1128. The WebSocket 1128 is a bidirectional communication module that enables a device acting as a server to push data to a client device (e.g., the mobile device 1102), rather than waiting for the client device to send a request for data, which the server then fills. In particular, the WebSocket 1128 operates in conjunction with the display manager 1126 to enable a device acting as a server to push items for display to a device acting as a client. For example, the WebSocket 1128 and the display manager 1126 work in conjunction to enable the support terminal 1106 to push a display element for display to the mobile device 1102.

As mentioned, and as illustrated in FIG. 11, the server(s) 1104 also includes the database 1130. The database 1130 operates as a database repository to store data for retrieval. The database 1130 can operate as an electronic cloud storage system (e.g., an electronic drop box). In particular, the database 1130 stores data for retrieval from a device. For example, the database 1130 can store a modified display element received from the mobile device 1102 until it is overwritten or retrieved by the support terminal 1106.

Additionally, as shown in FIG. 11, the server(s) 1104 includes the obscuring settings manager 1142. In particular, the obscuring settings manager 1142 can manage obscuring settings (e.g., distortion settings, panic button status) for users of the customer support system 114. To illustrate, the obscuring settings manager 1142 can obscure digital video streams in response to a request to obscure the digital video streams. Additionally, the obscuring settings manager 1142 can determine whether to block, hide, or distort digital video streams in response to a request to obscure the digital video streams. The obscuring settings manager 1142 can store the obscuring settings in the database 1130 for later retrieval.

As shown in FIG. 11, the server(s) 1104 further includes the video obscuring filter manager 1146. In particular, the video obscuring filter manager 1146 can generate distortion filters based on distortion settings for users. For example, the video obscuring filter manager 1146 can communicate with the obscuring settings manager 1142 to retrieve a particular distortion setting for a particular user. The video obscuring filter manager 1146 can then generate a distortion filter to include attributes (e.g., a distortion type and a distortion degree) based on the distortion setting. Additionally, the video obscuring filter manager 1146 can apply the distortion filter to one or more digital video streams presented at a client device (e.g., the support terminal 1106) associated with a particular user during digital video communications involving the user and based on one or more requests to obscure digital video streams.

Furthermore, as illustrated in FIG. 11, the support terminal 1106 includes the connection manager 1132. The connection manager 1132 searches for, detects, identifies, accepts, establishes, monitors, and maintains various types of connections. In particular, the connection manager 1132 establishes and maintains one or more connections between the support terminal 1106 and another device, such as the mobile device 1102. For example, when establishing a video chat between the mobile device 1102 and the support terminal 1106, the connection manager 1132 will establish and maintain a peer-to-peer connection through the duration of the video chat session.

As mentioned, and as illustrated in FIG. 11, the support terminal 1106 also includes the video chat manager 1134. The video chat manager 1134 initiates, provides for display, and maintains a digital video communication between the support terminal and another device, such as the mobile device 1102. In particular, the video chat manager 1134 operates in conjunction with the connection manager 1132 to establish and maintain a digital video communication between the support terminal 1106 and another device, such as a mobile device 1102.

Additionally, the video chat manager 1134 operates in conjunction with any number of user input/output devices, including, but not limited to cameras, microphones, display screens, touchscreens, and keypads.

As mentioned, and as illustrated in FIG. 11, the support terminal 1106 also includes the display element storage manager 1136. The display element storage manager 1136 stores display element triggers (and, possibly, display elements) that may be selected and transmitted to another device, such as the mobile device 1102. In particular, the display element storage manager 1136 operates in conjunction with the display element transmitter 1138 and the connection manager 1132 to transmit a display element trigger (and, possibly, a display element) across a connection. As mentioned above, in one or more embodiments, the mobile device 1102 stores the display elements corresponding to the display element triggers.

As mentioned, and as illustrated in FIG. 11, the support terminal 1106 also includes the display element transmitter 1138. The display element transmitter 1138 operates to transmit a display element across a connection to another device. In some embodiments, the display element transmitter 1138 operates to transmit a display element trigger (e.g., a check deposit trigger) across the connection. For example, the display element transmitter 1138 can transmit a display element trigger in conjunction with the corresponding display element.

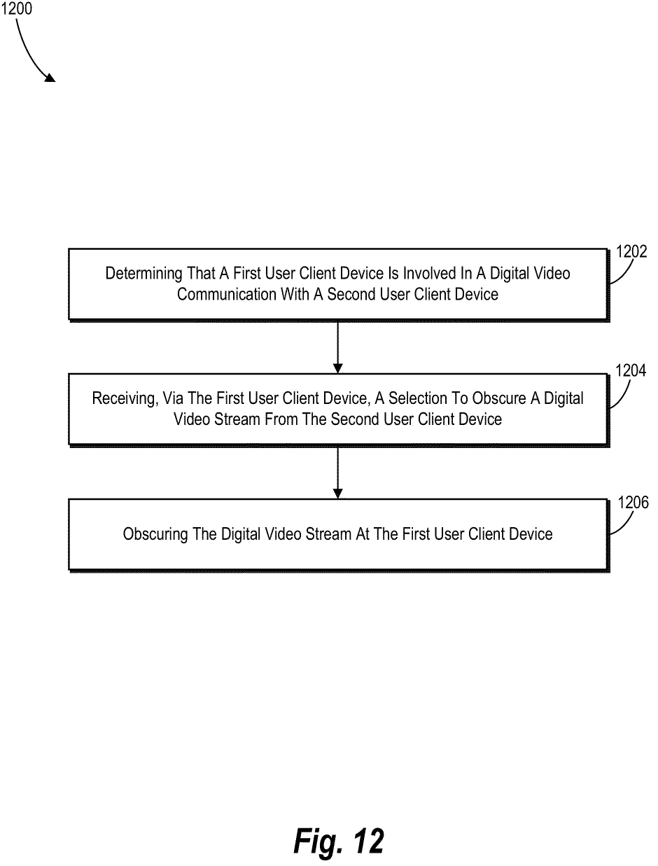

Turning now to FIG. 12, this figure shows a flowchart of a series of acts 1200 of obscuring digital video streams during ongoing digital video communications while maintaining connections corresponding to the digital video communications. While FIG. 12 illustrates acts according to one embodiment, alternative embodiments may omit, add to, reorder, and/or modify any of the acts shown in FIG. 12. The acts of FIG. 12 can be performed as part of a method. Alternatively, a non-transitory computer readable medium can comprise instructions, that when executed by one or more processors, cause a computing device to perform the acts of FIG. 12. In still further embodiments, a system can perform the acts of FIG. 12.

As shown, the series of acts 1200 includes an act 1202 of determining that a first user client device is involved in a digital video communication with a second user client device. For example, act 1202 can involve establishing, in response to a request to initiate a digital video communication between an agent associated with an agent client device and a user associated with a user client device, a connection between the agent client device and the user client device.

The series of acts 1200 also includes an act 1204 of receiving, via the first user client device, a selection to obscure a digital video stream from the second user client device. For example, act 1204 involves receiving, via the first user client device, a selection to obscure a digital video stream received from the second user client device at the first user client device during the digital video communication.

As part of act 1204, or as an additional act, the series of acts 1200 can include providing, for display at the agent client device, an option to obscure the digital video stream at the first user client device in response to determining that the first user client device is involved in the digital video communication with the second user client device. For example, the series of acts 1200 can include detecting the connection between the agent client device and the user client device. The series of acts 1200 can then include presenting, for display within a graphical user interface of the user client device, the option to obscure the digital video stream in response to detecting the connection.

In one or more embodiments, the series of acts 1200 includes providing, to an administrator client device, an interface element to enable the option to obscure the digital video stream at the agent client device. The series of acts 1200 can then include providing the option to obscure the digital video stream in response to detecting a selection of the interface element at the administrator client device.

Additionally, the series of acts 1200 includes an act 1206 of obscuring the digital video stream at the first user client device. For example, act 1206 involves obscuring, in response to the selection, the digital video stream at the first user client device while maintaining a connection corresponding to the digital video communication between the first user client device and the second user client device. To illustrate, the first user client device can include an agent client device.

Act 1206 can involve preventing the digital video stream from displaying at the first user client device. Act 1206 can involve applying a distortion filter to the digital video stream at the first user client device. For example, act 1206 can involve applying a blur filter to the digital video stream and muting a digital audio stream at the first user client device.

Act 1206 can also involve preventing, in response to the selection, the second user client device from receiving an additional digital video stream and a digital audio stream provided by the first user client device in connection with the digital video communication.

The series of acts 1200 can also include verifying the selection of an option to obscure the digital video stream. For example, the series of acts 1200 can include providing, for display at the first user client device and in response to the selection to obscure the digital video stream, a request to confirm or reject the selection to obscure the digital video stream. The series of acts 1200 can also include terminating the connection corresponding to the digital video communication based on a response confirming the selection to obscure the digital video stream. Alternatively, the series of acts 1200 can include resuming, based on a response rejecting the selection to obscure the digital video stream, displaying the digital video stream unobscured at the first user client device via the connection corresponding to the digital video communication.

The series of acts 1200 can include providing, for display at the first user client device and in response to the selection to obscure the digital video stream, a request to confirm the selection to obscure the digital video stream. The series of acts 1200 can further include generating, based on a response confirming the selection to obscure the digital video stream, a notification comprising a warning associated with content of the digital video stream. Additionally, the series of acts 1200 can include providing the notification for display at the second user client device.

In one or more embodiments, the series of acts 1200 includes an act of providing, to the second user client device a notification comprising a warning associated with content of the digital video stream. The series of acts 1200 can also include providing, for display at the first user client device in connection with providing the notification to the second user client device, a report interface comprising one or more options for reporting the content of the digital video stream to a third-party system. The series of acts 1200 can then include blocking a device location and a device identifier associated with the second user client device from engaging in digital video communications with the first user client device in connection with reporting the content of the digital video stream to the third-party system.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates a block diagram of exemplary computing device 1300 that may be configured to perform one or more of the processes described above. One will appreciate that one or more computing devices such as the computing device 1300 may implement the system(s) of FIG. 1. As shown by FIG. 13, the computing device 1300 can comprise a processor 1302, a memory 1304, a storage device 1306, an I/O interface 1308, and a communication interface 1310, which may be communicatively coupled by way of a communication infrastructure 1312. In certain embodiments, the computing device 1300 can include fewer or more components than those shown in FIG. 13. Components of the computing device 1300 shown in FIG. 13 will now be described in additional detail.

In one or more embodiments, the processor 1302 includes hardware for executing instructions, such as those making up a computer program. As an example, and not by way of limitation, to execute instructions for dynamically modifying workflows, the processor 1302 may retrieve (or fetch) the instructions from an internal register, an internal cache, the memory 1304, or the storage device 1306 and decode and execute them. The memory 1304 may be a volatile or non-volatile memory used for storing data, metadata, and programs for execution by the processor(s). The storage device 1306 includes storage, such as a hard disk, flash disk drive, or other digital storage device, for storing data or instructions for performing the methods described herein.

The I/O interface 1308 allows a user to provide input to, receive output from, and otherwise transfer data to and receive data from computing device 1300. The I/O interface 1308 may include a mouse, a keypad or a keyboard, a touch screen, a camera, an optical scanner, network interface, modem, other known I/O devices or a combination of such I/O interfaces. The I/O interface 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1308 is configured to provide graphical data to a display for presentation to a user. The graphical data may be representative of one or more graphical user interfaces and/or any other graphical content as may serve a particular implementation.

The communication interface 1310 can include hardware, software, or both. In any event, the communication interface 1310 can provide one or more interfaces for communication (such as, for example, packet-based communication) between the computing device 1300 and one or more other computing devices or networks. As an example, and not by way of limitation, the communication interface 1310 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1310 may facilitate communications with various types of wired or wireless networks. The communication interface 1310 may also facilitate communications using various communication protocols. The communication infrastructure 1312 may also include hardware, software, or both that couples components of the computing device 1300 to each other. For example, the communication interface 1310 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A non-transitory computer readable storage medium comprising instructions that, when executed by at least one processor, cause a computing device to:
determine that a first user client device is involved in a digital video communication with a second user client device;
receive, via the first user client device, a selection to obscure a digital video stream received from the second user client device at the first user client device during the digital video communication; and
obscure, in response to the selection, the digital video stream at the first user client device while maintaining a connection corresponding to the digital video communication between the first user client device and the second user client device.

2. The non-transitory computer readable storage medium as recited in claim 1, further comprising instructions that, when executed by the at least one processor, cause the computing device to obscure the digital video stream at the first user client device by preventing the digital video stream from displaying at the first user client device.

3. The non-transitory computer readable storage medium as recited in claim 1, further comprising instructions that, when executed by the at least one processor, cause the computing device to obscure the digital video stream at the first user client device by applying a distortion filter to the digital video stream at the first user client device.

4. The non-transitory computer readable storage medium as recited in claim 1, further comprising instructions that, when executed by the at least one processor, cause the computing device to:
provide, for display at the first user client device and in response to the selection to obscure the digital video stream, a request to confirm the selection to obscure the digital video stream; and
terminate the connection corresponding to the digital video communication based on a response confirming the selection to obscure the digital video stream.

5. The non-transitory computer readable storage medium as recited in claim 1, further comprising instructions that, when executed by the at least one processor, cause the computing device to:
provide, for display at the first user client device and in response to the selection to obscure the digital video stream, a request to confirm the selection to obscure the digital video stream;
generate, based on a response confirming the selection to obscure the digital video stream, a notification comprising a warning associated with content of the digital video stream; and
provide the notification for display at the second user client device.

6. The non-transitory computer readable storage medium as recited in claim 1, further comprising instructions that, when executed by the at least one processor, cause the computing device to:
provide, for display at the first user client device and in response to the selection to obscure the digital video stream, a request to confirm the selection to obscure the digital video stream; and
resume, based on a response rejecting the selection to obscure the digital video stream, displaying the digital video stream unobscured at the first user client device.

7. The non-transitory computer readable storage medium as recited in claim 1, further comprising instructions that, when executed by the at least one processor, cause the computing device to prevent, in response to the selection, the second user client device from receiving an additional digital video stream and a digital audio stream provided by the first user client device in connection with the digital video communication.

8. The non-transitory computer readable storage medium as recited in claim 1, further comprising instructions that, when executed by the at least one processor, cause the computing device to provide, for display at the first user client device, an option to obscure the digital video stream at the first user client device in response to determining that the first user client device is involved in the digital video communication with the second user client device.

9. A system comprising:
at least one processor; and
a non-transitory computer readable storage medium comprising instructions that, when executed by the at least one processor, cause the system to:
establish, in response to a request to initiate a digital video communication between an agent associated with an agent client device and a user associated with a user client device, a connection between the agent client device and the user client device;
provide, for display at the agent client device, an option to obscure a digital video stream received from the user client device at the agent client device during the digital video communication;
receive, via the user client device during the digital video communication, a selection of the option to obscure the digital video stream; and
obscure, in response to the selection, the digital video stream at the agent client device while maintaining the connection between the user client device and the agent client device.

10. The system as recited in claim 9, further comprising instructions that, when executed by the at least one processor, cause the system to obscure the digital video stream at the agent client device by preventing the digital video stream and a digital audio stream from being presented at the agent client device or by applying a blur filter to the digital video stream and muting the digital audio stream at the agent client device.

11. The system as recited in claim 9, further comprising instructions that, when executed by the at least one processor, cause the system to:
provide, to an administrator client device, an interface element to enable the option to obscure the digital video stream at the agent client device; and
provide the option to obscure the digital video stream in response to detecting a selection of the interface element at the administrator client device.

12. The system as recited in claim 9, further comprising instructions that, when executed by the at least one processor, cause the system to provide the option to obscure the digital video stream by:
detecting the connection between the agent client device and the user client device; and
presenting, for display within a graphical user interface of the user client device, the option to obscure the digital video stream in response to detecting the connection.

13. The system as recited in claim 9, further comprising instructions that, when executed by the at least one processor, cause the system to:
verify the selection of the option to obscure the digital video stream; and
terminate the connection corresponding to the digital video communication in response to verifying the selection to obscure the digital video stream.

14. The system as recited in claim 9, further comprising instructions that, when executed by the at least one processor, cause the system to provide, for display at the agent client device and in response to the selection of the option to obscure the digital video stream, a prompt to confirm or reject a request to obscure the digital video stream.

15. The system as recited in claim 14, further comprising instructions that, when executed by the at least one processor, cause the system to:
provide, for display at the agent client device and in response to the selection of the option to obscure the digital video stream, a prompt to confirm or reject a request to obscure the digital video stream;
generate, based on a confirmation of the request to obscure the digital video stream, a notification comprising a warning associated with content of the digital video stream; and
provide the notification for display at the user client device.

16. The system as recited in claim 14, further comprising instructions that, when executed by the at least one processor, cause the system to resume, based on a response rejecting the request to obscure the digital video stream, displaying the digital video stream unobscured at the agent client device via the connection corresponding to the digital video communication.

17. A method comprising:
establishing, in response to a request to initiate a digital video communication between an agent associated with an agent client device and a user associated with a user client device, a connection between the agent client device and the user client device;
providing, for display at the agent client device, an option to obscure a digital video stream received from the user client device at the agent client device during the digital video communication;
receiving, via the user client device during the digital video communication, a selection of the option to obscure the digital video stream;
obscuring, in response to the selection, the digital video stream at the agent client device while maintaining the connection between the user client device and the agent client device; and
providing, to the user client device, a notification comprising a warning associated with content of the digital video stream.

18. The method as recited in claim 17, further comprising:
providing, for display at the agent client device in connection with providing the notification to the user client device, a report interface comprising one or more options for reporting the content of the digital video stream to a third-party system; and
blocking a device location and a device identifier associated with the user client device from engaging in digital video communications with the agent client device in connection with reporting the content of the digital video stream to the third-party system.

19. The method as recited in claim 17, further comprising obscuring the digital video stream at the agent client device by:
preventing the digital video stream from displaying at the agent client device or applying a distortion filter to the digital video stream at the agent client device; and
preventing an additional digital video stream from the agent client device from displaying at the user client device.

20. The method as recited in claim 17, further comprising:
providing, for display at the agent client device and in response to the selection of the option to obscure the digital video stream, a request to confirm or reject the selection of the option to obscure the digital video stream; and
resuming, based on a response rejecting the selection of the option to obscure the digital video stream, displaying the digital video stream unobscured at the agent client device via the connection corresponding to the digital video communication.
